(19) United States
(12) Patent Application Publication
(10) Pub. No.: US 2023/0048540 A1
(43) Pub. Date: Feb. 16, 2023

(54) CARBON BLACK COMPOSITION TO IMPROVE AESTHETIC AND MECHANICAL PROPERTIES OF ELASTOMER COMPOUNDS

(71) Applicant: PCBL LIMITED, Kolkata (IN)

(72) Inventors: Shyam Lalit SINGH PATEL, Sonebhadara (IN); Nitya Narayan KUNTI, Vadodara (IN); Amit CHAKRABARTI, Howrah (IN); Mosongo MOUKWA, Bharuch (IN)

(73) Assignee: PCBL LIMITED, Kolkata (IN)

(21) Appl. No.: 17/758,682

(22) PCT Filed: Jan. 12, 2021
(86) PCT No.: PCT/IN2021/050031

§ 371 Date: Jul. 12, 2022

(30) Foreign Application Priority Data
Jan. 12, 2020 (IN) 201931051577

(51) Int. Cl. C08K 3/04

(52) U.S. Cl. CPC C08K 3/04; C08K 2201/006; C08K 2201/014

(57) ABSTRACT

This invention provides novel carbon black composition comprising of at least 5 one first carbon black, filler1, with iodine number in the range of about 25 to 160 mg/g, nitrogen surface area (NSA) in the range of 20 m²/g to 150 m²/g, with at least one second carbon black, filler 2, preferably, with iodine number in the range of 160 mg/g to 300 mg/g, nitrogen surface area (NSA) in the range of 160 m²/g to 300 m²/g oil absorption number (OAN) in the range of 50 10 ml/100 g to 120 ml/100 g, having synergistically enhanced distribution of width of aggregate size ΔD50 and elastomer compounds of natural rubber or synthetic rubbers or their predefined mixtures comprising said novel carbon black composition with improved properties such as tensile strength, elongation at break, tear strength, cut growth etc. along with improvement of the aesthetic 15 and colour properties of the elastomer compounds, such as, L* value etc.

### FIELD OF THE INVENTION

The invention relates to novel carbon black composition having synergistically enhanced distribution of width of aggregate size ΔD50, which when incorporated into elastomer compounds of natural rubber or synthetic rubbers or their predefined mixtures, improves the aesthetic and colour properties of the elastomer compounds, such as, L*value, and improves the mechanical properties, such as, tensile strength, elongation at break, tear strength, cut growth etc.

### BACKGROUND OF THE INVENTION

The appearance or aesthetic of tyre body parts, sidewall, various molded and extruded elastomerarticles deteriorates progressively with time or with continuous use, principally due to incorporation of carbon black grades, which inherently exhibits feeble colour performance, and further due to slow surface blooming of various chemical additives incorporated in elastomer formulations during compounding to protect the elastomer compounds from short and long term aging, make easy processing and so on. During continuous use, initiation of surface cracks and progressive growth of surface cracks also play significant role in loss of aesthetic of elastomer articles.

Beyond the appearance or aesthetic, the body part and sidewall elastomer compounds of tyres, molded elastomer articles, extruded elastomer articles, must satisfy certain performance needs, such as, mechanical properties, e.g. tensile strength, elongation at break, modulus, cutting/chipping resistance, abrasion resistance, cut initiation, cut growth, tear resistance and dynamical mechanical properties etc.

The rigor of these performance requirements varies widely with the type of tyre, on the kind of service the tyre will undergo, the application fields of the molded elastomer articles and extruded elastomer articles etc.

Commonly, carbon blacks are incorporated in elastomer formulations of tyre body parts, sidewall, molded articles and extruded articles to achieve the performance needs such as, mechanical properties, e.g. tensile strength, elongation at break, modulus, cutting/chipping resistance, abrasion resistance, cut initiation, cut growth, tear resistance and dynamical mechanical properties etc. of the article.

Two types of carbon black are commonly used by the rubber industry to reinforce rubber. The hard grade carbon black imparts high wear resistance to rubber into which it has been compounded and generally used to make vehicular tyre treads. Whereas soft grade carbon blacks are generally used to reinforce rubber where a great deal of flexing is expected to be encountered. Hard grade carbon blacks are commonly classified as being in the N100, N200, or N300 series. Soft grade carbon blacks are commonly classified as being in the N500, N600, and N700 series.

In addition, a range of carbon blacks, are available, which are still unlikely in use for elastomer applications because of the gap in understanding of effectiveness of those carbon blacks, when incorporated in elastomer compounds alone or in combination with other carbon blacks and due to processing challenges, cost etc. However, those carbon blacks have the potential to alter performance as well as non-functional properties of elastomer compounds e.g. mechanical properties, such as, tensile strength, elongation at break, modulus, tear strength, cut growth, electrical conducting properties, thermal conducting properties, colour properties, e.g. L* value, etc., when used judiciously in elastomer compounds.

Presently more than 50 grades of hard and soft grade carbon blacks with certain ranges of surface area (such as iodine adsorption number, and nitrogen surface area), structure (oil absorption number) are available commercially and use in elastomer compounds, both tyre and non-tyre applications. The use of these available hard and soft grades carbon blacks alone or in combination in elastomer compounds to optimize general performance characteristics of elastomer compounds covering viscosity, processing, curing, certain performance features are known in the prior art.

EP0609499A1 or U.S. Pat. No. 5,430,087 patents entitled carbon black pair with different particle size and improved rubber stock discloses development of an improved rubber stock with a unique carbon black system including mismatched and matched pairs of furnace blacks with fumed silica and a silane coupler. The carbon black system includes a mixture of large and small particles with high and low structure carbon black pairs. The carbon black system compounded with polar and nonpolar rubber provides products with a range of desirable characteristics using only two carbon blacks. The advancement claimed and disclosed carbon black composition comprising pairs of carbon black; however, fumed silica and silane coupler are also part of the claimed carbon black composition and rubber compound composition. High surface area carbon black (iodine adsorption number above 160 mg/g) not selected in the pairs of carbon black. The patent does not have any motive to show the improvement of colour performance (lowering L* value) of rubber compounds containing their carbon black composition.

The United states patent U.S. Pat. No. 6,627,693B1, entitled elastomeric compositions having improved appearance relates to compositions comprising an elastomer and a carbon black, which may be used to form articles having higher gloss and/or jetness than articles formed using an industry standard carbon black such as N650. The carbon blacks may be characterized by an iodine adsorption number from about 80 to about 400 mg/g, a DBP value of from about 50 to about 175 cc/100 g, a tint value of from about 100 to about 175% ITRB, a N2SA value of from about 80 to about 450 m<2>/g, and/or a CTAB value of from about 80 to about 300 m<2>/g. However, in the principal claim it claims the respective values having a DBP value of at least about 50 cc/100 g, a tint value of at least about 100% ITRB, and a CTAB value of at least about 80 m<2>/g without any upper limit. The advancement also described articles made from the composition, and processes for making the article. This prior art disclosed a carbon black of high surface area (iodine adsorption number 80 to 400 mg/g) to improve colour performance while cut resistance growth decreases with increase in surface area of carbon black in rubber compounds, also, the patent neither disclose nor claim a carbon black composition of two or more carbon black varying in surface area.

The European patent EP0866092, entitled tire with tread of rubber composition containing two different carbon blacks relates to a tire with a tread composed of a rubber composition containing carbon black reinforcement as significant quantities two different carbon blacks and without quantitative amounts of silica reinforcement. This patent disclosed a carbon black composition and rubber compounds based on the said carbon black composition. But the carbon black composition is exclusively between a hard grade and a soft grade carbon black of iodine adsorption number of maximum 130 mg/g, which may or may not contain silica.

The United states patent, US2012/0232216A1- entitled, filler blending for rubber formulations corresponding to using a target loading value and target intrinsic properties desired for a rubber formulation, two or more fillers are combined to create a blend having the desired intrinsic properties—i.e. a blend can be created emulating the desired intrinsic properties of a single filler system. In another exemplary aspect, knowing the individual loadings of fillers along with the target values desired for the loading of the blend and its intrinsic properties, individual intrinsic properties for at least one unknown filler that will be used to create the blend can be calculated. The unknown filler can then be identified by comparing the calculated intrinsic properties with the intrinsic properties of known fillers. This patent did not disclose or claim the carbon black composition, where one carbon black has the surface area greater than 130 m²/g.

From the traversal of prior arts above, it is clear that there exist a scope and need of development of carbon black composition grade comprising conventional soft and hard grade with carbon blacks of special features of very high surface area i.e. very high iodine adsorption number and nitrogen surface area, than conventional hard and soft grade carbon blacks to enhance the aesthetic of the articles as well as typical performance behaviors of an elastomer composition comprising aid carbon black composition grade having combination of conventional hard or soft grade carbon black with such high surface area carbon black.

### OBJECTIVE OF THE INVENTION

Thus, the prime objective of the present invention is to develop carbon black grade involving selective mixing of two carbon blacks providing synergistically enhanced distribution of width of aggregate size ΔD50 and incorporation of the same into elastomer compounds of natural rubber, synthetic rubber or their predefined mixture to provide for elastomeric compound having synergistically enhanced dispersibility of said carbon black.

Another objective of the present invention is to develop said carbon black grade comprising a first carbon black, filler 1, with iodine adsorption number in the range of about 25 to 160 mg/g, nitrogen surface area (NSA) in the range of 20 m²/g to 150 m²/g, oil absorption number (OAN) in the range of 70 ml/100 g to 140 ml/100 g, with at least one second carbon black, filler 2, with iodine adsorption number in the range of 160 mg/g to 300 mg/g, nitrogen surface area (NSA) in the range of 160 m²/g to 300 m²/g, oil absorption number (OAN) in the range of 50 ml/100 g to 120 ml/100 g wherein, the weight of the second carbon black, filler 2, in the carbon black composition grade is varying between 0.5 wt. % and 99.5 wt. %, preferably varying between 2.5 wt. % and 97.5 wt. %.

Another preferred objective of the present invention is to provide the elastomer compounds showing low L* value comprising a first carbon black, filler 1, with iodine adsorption number in the range of about 25 to 160 mg/g, nitrogen surface area (NSA) in the range of 20 m²/g to 150 m²/g, oil absorption number (OAN) in the range of 70 ml/100 g to 140 ml/100 g, with at least one second carbon black, filler 2, with iodine adsorption number in the range of 160 mg/g to 300 mg/g, nitrogen surface area (NSA) in the range of 160 m²/g to 300 m²/g, oil absorption number (OAN) in the range of 50 ml/100 g to 120 ml/100 g wherein, the weight of the second carbon black, filler 2, in the carbon black composition grade is varying between 0.5 wt. % and 99.5 wt. %, preferably varying between 2.5 wt. % and 97.5 wt. % carbon black composition grade.

In one objective of the present invention, the elastomer compounds will show improved tear strength comprising a first carbon black, filler 1, with iodine adsorption number in the range of about 25 to 160 mg/g, nitrogen surface area (NSA) in the range of 20 m²/g to 150 m²/g, oil absorption number (OAN) in the range of 70 ml/100 g to 140 ml/100 g, with at least one second carbon black, filler 2, with iodine adsorption number in the range of 160 mg/g to 300 mg/g, nitrogen surface area (NSA) in the range of 160 m²/g to 300 m²/g, oil absorption number (OAN) in the range of 50 ml/100 g to 120 ml/100 g wherein, the weight of the second carbon black, filler 2, in the carbon black composition grade is varying between 0.5 wt. % and 99.5 wt. %, preferably varying between 2.5 wt. % and 97.5 wt. % carbon black composition grade.

In another objective of the present invention, the elastomer compounds will show improved cut growth comprising a first carbon black, filler 1, with iodine adsorption number in the range of about 25 to 160 mg/g, nitrogen surface area (NSA) in the range of 20 m²/g to 150 m²/g, oil absorption number (OAN) in the range of 70 ml/100 g to 140 ml/100 g, with at least one second carbon black, filler 2, with iodine adsorption number in the range of 160 mg/g to 300 mg/g, nitrogen surface area (NSA) in the range of 160 m²/g to 300 m²/g, oil absorption number (OAN) in the range of 50 ml/100 g to 120 ml/100 g wherein, the weight of the second carbon black, filler 2, in the carbon black composition grade is varying between 0.5 wt. % and 99.5 wt. %, preferably varying between 2.5 wt. % and 97.5 wt. % carbon black composition grade.

Another objective of the present invention is to provide the elastomer compounds showing improved elongation at break comprising a first carbon black, filler 1, with iodine adsorption number in the range of about 25 to 160 mg/g, nitrogen surface area (NSA) in the range of 20 m²/g to 150 m²/g, oil absorption number (OAN) in the range of 70 ml/100 g to 140 ml/100 g, with at least one second carbon black, filler 2, with iodine adsorption number in the range of 160 mg/g to 300 mg/g, nitrogen surface area (NSA) in the range of 160 m²/g to 300 m²/g, oil absorption number (OAN) in the range of 50 ml/100 g to 120 ml/100 g wherein, the weight of the second carbon black, filler 2, in the carbon black composition grade is varying between 0.5 wt. % and 99.5 wt. %, preferably varying between 2.5 wt. % and 97.5 wt. % carbon black composition grade.

Another objective of the present invention is to provide the elastomer compounds showing improved tensile strength comprising a first carbon black, filler 1, with iodine adsorption number in the range of about 25 to 160 mg/g, nitrogen surface area (NSA) in the range of 20 m²/g to 150 m²/g, oil absorption number (OAN) in the range of 70 ml/100 g to 140 ml/100 g, with at least one second carbon black, filler 2, with iodine adsorption number in the range of 160 mg/g to 300 mg/g, nitrogen surface area (NSA) in the range of 160 m²/g to 300 m²/g, oil absorption number (OAN) in the range of 50 ml/100 g to 120 ml/100 g wherein, the weight of the second carbon black, filler 2, in the carbon black composition grade is varying between 0.5 wt. % and 99.5 wt. %, preferably varying between 2.5 wt. % and 97.5 wt. % carbon black composition grade.

### SUMMARY OF THE INVENTION

In the primary embodiment the present invention is directed to provide a carbon black composition suitable for elastomer compounds comprising,

a select combination of (a) at least one first carbon black, having iodine adsorption number in the range of about 25 to 160 mg/g, nitrogen surface area (NSA) in the range of 20 to 150 m²/g, oil absorption number (OAN) in the range of 70 to 140 ml/100 g; and (b) at least one second carbon black, having iodine adsorption number in the range of 160 to 300 mg/g, nitrogen surface area (NSA) in the range of 160 to 300 m²/g, oil absorption number (OAN) in the range of 50 to 120 ml/100 g, and wherein said second carbon black, in the carbon black composition vary between 0.5 wt. % and 99.5 wt. % having synergistically enhanced distribution of width of aggregate size ΔD50.

Another embodiment of the present invention is directed to provide said carbon black composition having synergistically enhanced distribution of width of aggregate size ΔD50 in the range of 50 nm to 160 nm and ratio of mass weighted average aggregate size, D_{W}, and number weighted average aggregate size, D_{N}, in the range of 1.4 to 4.02.

Another embodiment of the present invention is directed to provide the carbon black composition having measure of broadness of the aggregate size distribution curve without inferring the smaller and larger aggregate size defined by ΔD50/D_{Mode} in the range of 0.63 to 0.9.

Yet another embodiment of the present invention is directed to provide said carbon black composition, wherein selective combination of said first carbon black and said second carbon black enable selectively variable unimodal aggregate size distribution or bimodal aggregate size distribution.

Further embodiment of the present invention is directed to provide said carbon black composition comprising selective combinations including:

N339:EXP1=90:05, N339:EXP1=90:10, N339:EXP1=85:15, N339:EXP1=80:20, N339:EXP1=75:25, N339:EXP1=70:30, N339:EXP1=60:40, N339:EXP1=50:50, N234:EXP1=75:25, N134:EXP1=50:50, N134:EXP1=80:20, N134:EXP1=70:30, N660:EXP1=50:50, N660:EXP1=80:20, N660:EXP1=70:30, N774:EXP1=80:20, N774:EXP1=70:30, N774:EXP1=50:50, N774:EXP3=50:50, N550:EXP1=80:20, N550:EXP1=70:30, N550:EXP1=50:50 and N550:EXP2=50:50.

Still further embodiment of the present invention is directed to provide said carbon black composition comprising: carbon black composition, P23 (N339:EXP1=95:05), P24 (N339:EXP1=90:10), P25 (N339:EXP1=85:15), P26 (N339:EXP1=80:20), P29 (N339:EXP1=70:30), P30 (N339:EXP1=60:40), P31 (N339:EXP1=50:50), the value of ΔD50, and ΔD50/D_{Mode} synergistically increase from 63 nm and 0.625 (P22) to 88 nm and 0.93 with increase of wt. % of filler 2, EXP1, in filler 1, N339.

Another embodiment of the present invention is directed to provide said carbon black composition comprising: carbon black composition P37 (N134:EXP1=80:20), P36 (N134:EXP1=50:50), the value of ΔD50, and ΔD50/D_{Mode} synergistically increase from 55 nm and 0.695 (P35) to 58 nm and 0.88 with increase of wt. % of filler 2, EXP1 in filler 1, N134.

Yet another embodiment the present invention is directed to provide said carbon black composition comprising: Carbon black composition P40 (N660:EXP1=80:20), P39 (N660:EXP1=50:50), the value of ΔD50 changes synergistically, however, ΔD50/D_{Mode} do not change significantly, P38 (ΔD50−156 nm, ΔD50/D_{Mode} 0.831), P40 (ΔD50−157 nm, ΔD50/D_{Mode} 0.86) and P39 (ΔD50−153 nm, ΔD50/D_{Mode} 0.856) with increase of wt. % of filler 2, EXP1 in filler 1, N660.

According to a preferred aspect of the present invention is directed to provide an elastomer formulation incorporating carbon black composition including; said carbon black composition having select combination of (A) at least one first carbon black, having iodine adsorption number in the range of about 25 to 160 mg/g, nitrogen surface area (NSA) in the range of 20 to 150 m2/g, oil absorption number (OAN) in the range of 70 to 140 ml/100 g; and (b) at least one second carbon black, having iodine adsorption number in the range of 160 to 300 mg/g, nitrogen surface area (NSA) in the range of 160 to 300 m2/g oil absorption number (OAN) in the range of 50 to 120 ml/100 g, and wherein said second carbon black, in the carbon black composition vary between 0.5 wt. % and 99.5 wt. % having synergistically enhanced distribution of width of aggregate size ΔD50 and (B) selectively co-acting rubber compounds having enhanced dispersibility of carbon black in the elastomer compound in the range of 87.71 to 99.87%, wherein said selectively co-acting rubber compounds include at least one homo- or co-polymers of natural rubber, epoxidized natural rubber, styrene butadiene rubber (SBR), polybutadiene rubber (PBR), butyl rubber (IIR), chlorobutyl rubber (CIIR), bromobutyl rubber, neoprene rubber (CR), nitrile rubber (NBR), ethylene propylene rubber (EPR), ethylene propylene diene rubber (EPDM), ethylene vinyl acetate (EVA) rubber, polyacrylic rubber, polysulfide rubber, silicone rubbers, fluoro elastomers or thermoplastic elastomer preferably NR/BR, SBR/BR, NBR, EPDM and IIR.

Another embodiment of the present invention is directed to provide said elastomeric formulation, wherein the said proportion of carbon black composition: selectively co-acting rubber compounds is in the range of 0.05 phr to 150 phr enhanced aesthetic and colour properties including L* value in the range of about 25.0 to about 3.0, favour selectively enhanced aesthetic and colour properties including L* value in the range of 15.38 to 5.05; tear strength in the range of about 15 N/mm to about 250 N/mm, more preferably in the range of 33 N/mm to 198 N/mm, improvement of about 240% to 750% elongation at break.

Another aspect of the present invention is directed to provide said elastomeric formulation comprising

filler 1, N339 having iodine adsorption number, 89.00 mg/g; nitrogen surface area (NSA), 86.20 m2/g; oil absorption number (OAN), 119.8 ml/100 g; and filler 2, EXP1 B219 having iodine adsorption number, 256.75 mg/g; NSA 262.98 m2/g; oil absorption number (OAN), 94.8 ml/100 g with 50 wt. % of the total carbon black composition at total 45 phr carbon black N339 loading achieve a tear strength in the range of 145 N/mm to 155 N/mm.

Yet another aspect of the present invention is directed to provide said elastomeric formulation wherein.

filler 1 (N660), iodine adsorption number, 37.5 mg/g; NSA) 35.1 m2/g; oil absorption number (OAN), 91.2 ml/100 g; and

filler 2, EXP1 B219 having iodine adsorption number, 256.75 mg/g; NSA 262.98 m2/g; oil absorption number (OAN), 94.8 ml/100 g with 50 wt. % of the total carbon black composition at total 45 phr carbon black N660 loading achieve a tear strength in the range of 45 N/mm to 55 N/mm.

Another aspect of the present invention is directed to provide said elastomeric formulation, wherein

filler 1 (N134), having iodine adsorption number, 146.75 mg/g; NSA, 139.9 m2/g; oil absorption number (OAN), 121.4 ml/100 g and

filler 2, EXP1 B219 having iodine adsorption number, 256.75 mg/g; NSA 262.98 m2/g; oil absorption number (OAN), 94.8 ml/100 g with 50 wt. % of the total carbon black composition at total 45 phr carbon black N134 loading achieve a tear strength in the range of 195 N/mm to 210 N/mm.

Further embodiment of the present invention is directed to provide said elastomeric formulation wherein

filler 1 (N774), iodine adsorption number, 30.5 mg/g; NSA, 31.5 m2/g; oil absorption number (OAN), 73.0 ml/100 g (OAN) and

filler 2, EXP1 B219 having iodine adsorption number, 256.75 mg/g; NSA 262.98 m2/g; oil absorption number (OAN), 94.8 ml/100 g with 50 wt. % of the total carbon black composition

or filler 2 (B361) Iodine adsorption number 292.0 mg/g; NSA 294.0 m2/g; oil absorption number 70 ml/100 gat 50 wt. % of total carbon black composition exhibit about 90 N/mm to 105 N/mm tear strength.

Yet further embodiment of the present invention is directed to provide said elastomeric formulation wherein

filler 1 (N134), having iodine adsorption number, 146.75 mg/g; NSA, 139.9 m2/g; oil absorption number (OAN), 121.4 ml/100 g and

filler 2, EXP1 B219 having iodine adsorption number, 256.75 mg/g; NSA 262.98 m2/g; oil absorption number (OAN), 94.8 ml/100 g with 50 wt. % of the total carbon black composition

exhibit about 100 N/mm to 115 N/mm tear strength.

Further embodiment of the present invention is directed to provide said elastomeric formulation, wherein

filler 1 (N660), iodine adsorption number, 37.5 mg/g; NSA) 35.1 m2/g; oil absorption number (OAN), 91.2 ml/100 g; and

filler 2, EXP1 B219 having iodine adsorption number, 256.75 mg/g; NSA 262.98 m2/g; oil absorption number (OAN), 94 ml/100 g with 50 wt. % of the total carbon black composition

exhibit about 70 N/mm to 85 N/mm tear strength.

Still further aspect of the present invention is directed to provide said elastomeric formulation, wherein

filler 1 (N550), having iodine adsorption number, 43.2 mg/g; NSA, 36.09 m2/g; oil absorption number (OAN), 121 ml/100 g; and

filler 2, EXP1 B219 having iodine adsorption number, 256.75 mg/g; NSA 262.98 m2/g; oil absorption number (OAN), 94.8 ml/100 g with 50 wt. % of the total carbon black composition

or

filler 2 (N115) having—Iodine adsorption number 162.0 mg/g; NSA 156.0 m2/g; oil absorption number 115.0 ml/100 g with 50 wt. % of total carbon black composition

exhibit about 40 N/mm to 55 N/mm tear strength.

Another embodiment of the present invention is directed to provide said elastomeric formulation, wherein

filler 1 N339 having iodine adsorption number, 89.0 mg/g; nitrogen surface area (NSA), 86.2 m2/g; oil absorption number (OAN), 119.8 ml/100 g; and

filler 2, EXP1 B219 having iodine adsorption number, 256.75 mg/g; NSA 262.98 m2/g; oil absorption number (OAN), 94.8 ml/100 g with 50 wt. % of the total carbon black composition

exhibit 5.5 to 3.5 L* value.

Another embodiment of the present invention is directed to provide said elastomeric formulation, wherein

Filler 1 N660 having iodine adsorption number, 37.5 mg/g; nitrogen surface area (NSA), 35.1 m2/g; oil absorption number (OAN), 91.2 ml/100 g; and

filler 2, EXP1 B219 having iodine adsorption number, 256.75 mg/g; NSA 262.98 m2/g; oil absorption number (OAN), 94.8 ml/100 g with 50 wt. % of the total carbon black composition

exhibit about 10.5 to 9.5 L* value.

Yet another embodiment of the present invention is directed to provide said elastomeric formulation, wherein

filler 1 N134 having iodine adsorption number, 146.75 mg/g; NSA, 139.9 m2/g; oil absorption number (OAN), 121.4 ml/100 g and

filler 2, EXP1 B219 having iodine adsorption number, 256.75 mg/g; NSA 262.98 m2/g; oil absorption number (OAN), 94.8 ml/100 g with 50 wt. % of the total carbon black composition

exhibit about 10.5 to 9.5 L* value.

Further embodiment of the present invention is directed to provide said elastomeric formulation wherein

Filler 1 N774 having iodine adsorption number, 30.5 mg/g; NSA, 31.5 m2/g; oil absorption number (OAN), 73.0 ml/100 g (OAN) and

Filler 2 EXP1 B219 having iodine adsorption number, 256.75 mg/g; NSA 262.98 m2/g; oil absorption number (OAN), 94.8 ml/100 g with 50 wt. % of the total carbon black composition

exhibit about 7.8 to 6.8 L* value.

Still further embodiment of the present invention is directed to provide said elastomeric formulation, wherein

filler 1 N774 having iodine adsorption number, 30.5 mg/g; NSA, 31.5 m2/g; oil absorption number (OAN), 73 ml/100 g (OAN) and

filler 2 EXP 3 (B361) having Iodine adsorption number 292.0 mg/g; NSA 294.0 m2/g; oil absorption number 70.0 ml/100 g; with 50 wt. % of the total carbon black composition

exhibit about 7.5 to 6.5 L* value.

Yet further embodiment of the present invention is directed to provide said elastomeric formulation, wherein

filler 1 (N550), having iodine adsorption number, 43.2 mg/g; NSA, 36.09 m2/g; oil absorption number (OAN), 119.6 ml/100 g and

filler 2, EXP1 B219 having iodine adsorption number, 256.75 mg/g; NSA 262.98 m2/g; oil absorption number (OAN), 94.8 ml/100 g with 50 wt. % of the total carbon black composition

exhibit about 6.5 to 5.5 L* value.

Another embodiment of the present invention is directed to provide said elastomeric formulation, wherein

filler 1 N550 having iodine adsorption number, 43.2 mg/g; NSA, 36.09 m2/g; oil absorption number (OAN), 121 ml/100 g and

filler 2 EXP2 (N115)—having Iodine adsorption number 162 mg/g; NSA 156 m2/g; oil absorption number 115 ml/100 g with 50 wt. % of the total carbon black composition

exhibit about 8.5 to 7.5 L* value.

Another embodiment of the present invention is directed to provide said elastomeric formulation, wherein

filler 1 N660 having iodine adsorption number, 37.5 mg/g; nitrogen surface area (NSA), 35.1 m2/g; oil absorption number (OAN), 91.2 ml/100 g; and

filler 2, EXP1 B219 having iodine adsorption number, 256.75 mg/g; NSA 262.98 m2/g; oil absorption number (OAN), 94.8 ml/100 g with 50 wt. % of the total carbon black composition

exhibit to 10.0 mm to 9.0 mm cut growth for 10 KC and 15.0 mm to 14.0 mm for 20 KC with a total carbon black loading of 45 phr.

Yet another embodiment of the present invention is directed to provide said elastomeric formulation, wherein

filler 1 N774 having iodine adsorption number, 30.5 mg/g; NSA, 31.5 m2/g; oil absorption number (OAN), 73.0 ml/100 g (OAN) and

filler 2 EXP1 B219 having iodine adsorption number, 256.75 mg/g; NSA 262.98 m2/g; oil absorption number (OAN), 94.8 ml/100 g with 50 wt. % of the total carbon black composition

exhibit about 13.0 mm to 12.0 mm cut growth for 10 KC with a total carbon black loading of 70 phr.

Further embodiment of the present invention is directed to provide said elastomeric formulation, wherein

filler 1 N134 having iodine adsorption number, 146.75 mg/g; NSA, 139.9 m2/g; oil absorption number (OAN), 121.4 ml/100 g and

filler 2, EXP1 B219 having iodine adsorption number, 256.75 mg/g; NSA 262.98 m2/g; oil absorption number (OAN), 94.8 ml/100 g with 50 wt. % of the total carbon black composition

exhibit about 9.0 mm to 8.0 mm cut growth for 10 KC and 13.0 mm to 12.0 mm for 20 KC with a total carbon black loading of 60 phr.

Still further embodiment of the present invention is directed to provide said elastomeric formulation, wherein

filler 1 N339 having iodine adsorption number, 89.0 mg/g; nitrogen surface area (NSA), 86.2 m2/g; oil absorption number (OAN), 119.8 ml/100 g; and

filler 2, EXP1 B219 having iodine adsorption number, 256.75 mg/g; NSA 262.98 m2/g; oil absorption number (OAN), 94.8 ml/100 g with 50 wt. % of the total carbon black composition

or

filler 1 N660 having iodine adsorption number, 37.5 mg/g; nitrogen surface area (NSA), 35.1 m2/g; oil absorption number (OAN), 91.2 ml/100 g; and

filler 2, EXP1 B219 having iodine adsorption number, 256.75 mg/g; NSA 262.98 m2/g; oil absorption number (OAN), 94.8 ml/100 g with 50 wt. % of the total carbon black composition

or

filler 1 (N550), having iodine adsorption number, 43.2 mg/g; NSA, 36.09 m2/g; oil absorption number (OAN), 119.6 ml/100 g and

filler 2, EXP1 B219 having iodine adsorption number, 256.75 mg/g; NSA 262.98 m2/g; oil absorption number (OAN), 94.8 ml/100 g with 50 wt. % of the total carbon black composition

or

filler 1 N774 having iodine adsorption number, 30.5 mg/g; NSA, 31.5 m2/g; oil absorption number (OAN), 73.0 ml/100 g (OAN) and

filler 2 EXP1 B219 having iodine adsorption number, 256.75 mg/g; NSA 262.98 m2/g; oil absorption number (OAN), 94.8 ml/100 g with 50 wt. % of the total carbon black composition

exhibit about 240% to 750% elongation at break.

Yet further embodiment of the present invention is directed to provide said elastomeric formulation, wherein

filler 1 N339 having iodine adsorption number, 89.0 mg/g; nitrogen surface area (NSA), 86.2 m2/g; oil absorption number (OAN), 119.8 ml/100 g; and

filler 2, EXP1 B219 having iodine adsorption number, 256.75 mg/g; NSA 262.98 m2/g; oil absorption number (OAN), 94.8 ml/100 g with 50 wt. % of the total carbon black composition

or

filler 1 N660 having iodine adsorption number, 37.5 mg/g; nitrogen surface area (NSA), 35.1 m2/g; oil absorption number (OAN), 91.2 ml/100 g; and

filler 2, EXP1 B219 having iodine adsorption number, 256.75 mg/g; NSA 262.98 m2/g; oil absorption number (OAN), 94.8 ml/100 g with 50 wt. % of the total carbon black composition

or

filler 1 (N550), having iodine adsorption number, 43.2 mg/g; NSA, 36.09 m2/g; oil absorption number (OAN), 119.6 ml/100 g and,

filler 2, EXP1 B219 having iodine adsorption number, 256.75 mg/g; NSA 262.98 m2/g; oil absorption number (OAN), 94.8 ml/100 g with 50 wt. % of the total carbon black composition or

filler 1 N774 having iodine adsorption number, 30.5 mg/g; NSA, 31.5 m2/g; oil absorption number (OAN), 73.0 ml/100 g (OAN) and

filler 2 EXP1 B219 having iodine adsorption number, 256.75 mg/g; NSA 262.98 m2/g; oil absorption number (OAN), 94.8 ml/100 g with 50 wt. % of the total carbon black composition

exhibit about 6.0 MPa to 28.0 MPa tensile strength.

According to a preferred aspect of the present invention is directed to provide a process for the manufacture of said carbon black composition involving desired synergistically enhanced distribution of width of aggregate size ΔD50 suitable for elastomer compounds comprising

mixing a select combination of (a) at least one first carbon black, having iodine adsorption number in the range of about 25 to 160 mg/g, nitrogen surface area (NSA) in the range of 20 to 150 m2/g, oil absorption number (OAN) in the range of 70 to 140 ml/100 g; and (b) at least one second carbon black, having iodine adsorption number in the range of 160 to 300 mg/g, nitrogen surface area (NSA) in the range of 160 to 300 m2/g oil absorption number (OAN) in the range of 50 to 120 ml/100 g, and wherein said second carbon black, in the carbon black composition very between 0.5 wt. % and 99.5 wt. % having synergistically enhanced distribution of width of aggregate size ΔD50 in the range of 50 nm to 160 nm and ratio of mass weighted average aggregate size, D_{W}, and number weighted average aggregate size, D_{N} in the range of 1.4 to 4.02.

Another aspect of the present invention is directed to provide a process for the manufacture of elastomer compound incorporating said carbon black composition comprising:

involving a select combination of (A) carbon black composition of (a) at least one first carbon black, having iodine adsorption number in the range of about 25 to 160 mg/g, nitrogen surface area (NSA) in the range of 20 to 150 m2/g, oil absorption number (OAN) in the range of 70 to 140 ml/100 g; and (b) at least one second carbon black, having iodine adsorption number in the range of 160 to 300 mg/g, nitrogen surface area (NSA) in the range of 160 to 300 m2/g oil absorption number (OAN) in the range of 50 to 120 ml/100 g, and wherein said second carbon black, in the carbon black composition vary between 0.5 wt. % and 99.5 wt. % having synergistically enhanced distribution of width of aggregate size ΔD50 and (B) co-acting rubber compounds and following processing for producing elastomeric compounds with enhanced dispersibility of carbon black in the elastomer compound in the range of 87.71 to 99.87%.

Another aspect of the present invention is directed to provide said elastomeric compound having synergistically enhanced dispersion of carbon black including: said dispersion of combination of (a) at least one first carbon black, having iodine adsorption number in the range of about 25 to 160 mg/g, nitrogen surface area (NSA) in the range of 20 to 150 m2/g, oil absorption number (OAN) in the range of 70 to 140 ml/100 g; and (b) at least one second carbon black, having iodine adsorption number in the range of 160 to 300 mg/g, oil absorption number (OAN) in the range of 50 to 120 ml/100 g, and wherein said second carbon black, having synergistically enhanced distribution of width of aggregate size ΔD50 in the range of 50 nm to 160 nm and having measure of broadness of the aggregate size distribution curve without inferring the smaller and larger aggregate size defined by ΔD50/D_{Mode} in the range of 0.63 to 0.9. yet another aspect of the present invention is directed to provide said elastomeric compounds comprising rubber compounds including at least one homo- or co-polymers of natural rubber, epoxidized natural rubber, styrene butadiene rubber (SBR), polybutadiene rubber (PBR), butyl rubber (IIR), chlorobutyl rubber (CIIR), bromobutyl rubber, neoprene rubber (CR), nitrile rubber (NBR), ethylene propylene rubber (EPR), ethylene propylene diene rubber (EPDM), ethylene vinyl acetate (EVA) rubber, polyacrylic rubber, polysulfide rubber, silicone rubbers, fluoro elastomers or thermoplastic elastomer preferably NR/BR, SBR/BR, NBR, EPDM and IIR

Further aspect of the present invention is directed to provide said elastomeric compound having improved aesthetic, colour, mechanical properties including selectively L* value in in the range of 15.38 to 5.05; tear strength in in the range of 33 N/mm to 198 N/mm; cut growth in the range of 26.38 mm to 8.78 mm; tensile strength in the range of 5.57 MPa to 25.06 MPa and elongation at break in the range of 208% to 732%.

### DESCRIPTION OF THE INVENTION

Materials Used

Rubber

1. Natural Rubber (NR)—commercially available Ribbed Smoke Sheet (RSS) of ML (1+4100°) C of 50+—5 from Indian Rubber Board, Kottayam.

2. Polybutadiene (BR)—commercially available Reflex 1220 of 96% cis content from Reliance Industries Ltd. India.

3. Styrene Butadiene Rubber (SBR)—commercially available Oil extended (37.5 wt %) SBR containing 23.5 parts styrene from Reliance Industries Ltd., India.

4. Ethylene Propylene Diene Monomer (EPDM) based rubber-commercially available (ENB-5.7%, Ethylene 65% and Propylene 35%), from Rajshila Synthetics Pvt. Ltd., India.

5. Nitrile Butadiene Rubber (NBR)— commercially available NBR (acrylonitrile content-35%), from Anant Poly Rubb Pvt. Ltd., India.

6. Butyl rubber (IIR)— commercially available supplied by Flexils Pvt. Ltd, India.

Filler

7. Semi-reinforcing Carbon Black—

The carbon blacks used for the invention are
i) Hard carbon black—N339, iodine adsorption number, 89.00 mg/g; nitrogen surface area (NSA), 86.2 m2/g; oil absorption number (OAN), 119.8 ml/100 g; Phillips Carbon Black Limited (PCBL).
ii) Hard carbon black—N134, iodine adsorption number, 146.75 mg/g; NSA, 139.90 m2/g; oil absorption number (OAN), 121.4 ml/100 g; PCBL.
iii) Hard carbon black—N234, iodine adsorption number, 121.5 mg/g; NSA, 115.8 m2/g; oil absorption number (OAN), 121.9 ml/100 g; PCBL.
iv) Soft carbon black—N550, iodine adsorption number, 43.20 mg/g; NSA, 36.09 m2/g; oil absorption number (OAN), 119.6 ml/100 g; PCBL.
v) Soft carbon black—N774, iodine adsorption number, 30.50 mg/g; NSA, 31.5 m2/g; oil absorption number (OAN), 73.0 ml/100 g; PCBL.
vi) Soft carbon black—N660, iodine adsorption number, 37.50 mg/g; NSA) 35.10 m2/g; oil absorption number (OAN), 91.2 ml/100 g; PCBL.

The special carbon black used for the invention are
vii) EXP1 B219, iodine adsorption number, 256.75 mg/g; NSA 262.98 m2/g; oil absorption number (OAN), 94.8 ml/100 g; PCBL.
viii) EXP 2 (N115)—Iodine adsorption number 162.00 mg/g; NSA 156.00 m2/g; oil absorption number 115.0 ml/100 g; PCBL.
ix) EXP 3 (B361)—Iodine adsorption number 292.00 mg/g; NSA 294.00 m2/g; oil absorption number 70.0 ml/100 g; PCBL.

Rubber Curing System

8. Curing Agent—Sulphur powder (purity 99.5%) from LobaChemie Pvt. Ltd.

9. Accelerator—N-cyclohexyl-2-benzothiazolesulfenamide (CBS) from NOCIL Ltd., India. —2-Mercaptobenzothiazole (MBT), Tetramethylthiuram disulfide (TMTD), (2,2′ Dibenzothiazyl Disulfide or 2,2′-Dithiobisbenzo Thiazole (MBTS), and Zinc DibutylDithiocarbonate (ZDBC) all from Advance Chemical Pvt. Ltd., India

10. Retarder—N-(Cyclohexylthio) phthalimide (CTP, PVI)—Non-staining and Non-discoloringVulcanizationinhibitorNOCILLtd., India.

11. Activator—Zinc oxide (ZnO) for vulcanization of rubber—from Avantor Performance Materials India Ltd., India, and Stearic Acid from LobaChemie Pvt. Ltd., India.

Stabilizer

12. Thermal Stabilizer—2,2,4-Trimethyl-1,2-dihydroquinoline (TMQ) from NOCIL Ltd., India.

13. Weathering Stabilizer—N-(1,3-Dimethylbutyl)-N′-phenyl-p-phenylenediamine (6PPD) containing 27.5 part of highly aromatic oil.

14. Microcrystalline Wax—Protection against ozone attack.

Processing Aids

15. Oil—Aromatic oil from Viswaat Chemicals Ltd., India; Paraffinic oil from Supplied by Advance Chemical Pvt. Ltd., India. DOP oil Supplied by Vraj Chem Pvt Ltd., India.

16. Peptizer—Control viscosity from NOCIL Ltd., India.

Equipment Used:

1. Banburry Mixer—Kobelco, Japan.

2. Two Roll Mill—Santosh Engineering Pvt. Ltd., India.

3. Molding Press—Santosh Engineering Pvt. Ltd., India.

4. Oscillating Disc Rheometer (ODR)—ODR2000, Alfa Technology, USA.

5. Universal Testing Machine (UTM)—Instron 3366, Instron, UK.

6. Rubber Process Analyzer (RPA)—RPA 93001, Alfa Technology, USA.

7. Demattia Flexing Tester—Serial No— 6501.1.1, Prolific engineers, India.

8. Aggregate Size Analyzer—BI-DCP, Brookhaven Instrument Corporation, USA.

9. Spectrophotometer—AGERA Spectrophotometer, Hunterlab, USA.

10. Tint Tester—Tint Tester 527, Erichsen, USA.

11. Absorpometer—HITECH, DABS, Luxemdourg, Germany.

12. Dispersion Grader—91001SR, Alfa technology, USA.

Preparation of Carbon Black Composition Grade

The carbon black composition grade of predefined composition is made by mixing one first carbon black, filler 1, with iodine adsorption number in the range of about 25 to 160 mg/g, preferably, in the range of about 40 to 150 mg/g; nitrogen surface area (NSA) in the range of 20 to 150 m2/g, preferably, in the range of 35 to 140 m2/g; oil absorption number (OAN) in the range of 70 to 140 ml/100 g, more preferably, in the range of 80 to 125 ml/100 g with at least one second carbon black, filler 2, preferably, with iodine adsorption number in the range of 160 to 300 mg/g, nitrogen surface are in range of 160 to 300 m2/g, oil absorption number (OAN) in the range of 50 to 120 ml/100 g, wherein, the weight of the second carbon black, filler 2, in the carbon black composition grade is varying between 0.5 wt % and 99.5 wt %. The filler 1 and filler 2 can be selected in the form of pellet or powder. The selected predefined composition of ‘filler 1’ and ‘filler 2’ is shown in Table 1. In this patent application the terms carbon black composition and carbon black composition grade are used interchangeably.

TABLE 1
Carbon Black compositionsGrade.

| | | | Feed Rate*, kg/h |
|---|---|---|---|
| | | | Feeder 1 - |
| | | Amount of | ‘Filler 1’ |
| | Carbon Black | Carbon Black | Feeder 2 - |
| Sample No. | Composition | in kg. | ‘Filler 2’ |
| P22 | N339:EXP1 = 100:00 | N339: 5.0 | Feeder 1 - 10.0 |
| | | EXP1: 0 | Feeder 2 - 0.0 |
| P23 | N339:EXP1 = 95:05 | N339: 4.75 | Feeder 1 - 9.5 |
| | | EXP1: 0.25 | Feeder 2 - 0.5 |
| P24 | N339:EXP1 = 90:10 | N339: 4.50 | Feeder 1 - 9.0 |
| | | EXP1: 0.50 | Feeder 2 - 1.0 |
| P25 | N339:EXP1 = 85:15 | N339: 4.25 | Feeder 1 - 8.5 |
| | | EXP1: 0.75 | Feeder 2 - 1.5 |
| P26 | N339:EXP1 = 80:20 | N339: 4.00 | Feeder 1 - 8.0 |
| | | EXP1: 1.00 | Feeder 2 - 2.0 |
| P27 | N339:EXP1 = 75:25 | N339: 3.75 | Feeder 1 - 7.5 |
| | | EXP1: 1.25 | Feeder 2 - 2.5 |
| P28 | EXP1 = 100 | N339: 0 | Feeder 1 - 0.0 |
| | | EXP1: 5.0 | Feeder 2 - 10.0 |
| P29 | N339:EXP1 = 70:30 | N339: 3.5 | Feeder 1 - 7.0 |
| | | EXP1: 1.5 | Feeder 2 - 3.0 |
| P30 | N339:EXP1 = 60:40 | N339: 3.0 | Feeder 1 - 6.0 |
| | | EXP1: 2.0 | Feeder 2 - 4.0 |
| P31 | N339:EXP1 = 50:50 | N339: 2.5 | Feeder 1 - 5.0 |
| | | EXP1: 2.5 | Feeder 2 - 5.0 |
| P32 | N234:EXP1 = 100:00 | N234: 5.0 | Feeder 1 - 10.0 |
| | | EXP1: 0 | Feeder 2 - 0 |
| P33 | N234:EXP1 = 75:25 | N234: 3.75 | Feeder 1 - 7.5 |
| | | EXP1: 1.25 | Feeder 2 - 2.5 |
| P35 | N134:EXP1 = 100:00 | N134: 5.0 | Feeder 1 - 10.0 |
| | | EXP1: 0 | Feeder 2 - 0.0 |
| P36 | N134:EXP1 = 50:50 | N134: 2.5 | Feeder 1 - 5.0 |
| | | EXP1: 2.5 | Feeder 2 - 5.0 |
| P37 | N134:EXP1 = 80:20 | N134: 4.00 | Feeder 1 - 8.0 |
| | | EXP1: 1.00 | Feeder 2 - 2.0 |
| P58 | N134:EXP1 = 70:30 | N134: 3.5 | Feeder 1 - 7.0 |
| | | EXP1: 1.5 | Feeder 2 - 3.0 |
| P38 | N660:EXP1 = 100:00 | N660: 5.0 | Feeder 1 - 10.0 |
| | | EXP1: 0 | Feeder 2 - 0.0 |
| P39 | N660:EXP1 = 50:50 | N660: 2.5 | Feeder 1 - 5.0 |
| | | EXP1: 2.5 | Feeder 2 - 5.0 |
| P40 | N660:EXP1 = 80:20 | N660: 4.00 | Feeder 1 - 8.0 |
| | | EXP1: 1.00 | Feeder 2 - 2.0 |
| P48 | N660:EXP1 = 70:30 | N660: 3.5 | Feeder 1 - 7.0 |
| | | EXP1: 1.5 | Feeder 2 - 3.0 |
| P41 | N774:EXP1 = 100:00 | N774: 5.0 | Feeder 1 - 10.0 |
| | | EXP1: 0 | Feeder 2 - 0 |
| P42 | N774:EXP1 = 80:20 | N774: 4.0 | Feeder 1 - 8.0 |
| | | EXP1: 1.00 | Feeder 2 - 2.0 |
| P43 | N774:EXP1 = 70:30 | N774: 3.5 | Feeder 1 - 7.0 |
| | | EXP1: 1.5 | Feeder 2 - 3.0 |
| P44 | N774:EXP1 = 50:50 | N774: 2.5 | Feeder 1 - 5.0 |
| | | EXP1: 2.5 | Feeder 2 - 5.0 |
| P63 | N774:EXP3 = 50:50 | N774: 2.5 | Feeder 1 - 5.0 |
| | | EXP3: 2.5 | Feeder 2 - 5.0 |
| P51 | N550:EXP1 = 100:00 | N550: 5.0 | Feeder 1 - 10.0 |
| | | EXP1: 0 | Feeder 2 - 0 |
| P52 | N550:EXP1 = 80:20 | N550: 4.0 | Feeder 1 - 8.0 |
| | | EXP1: 1.0 | Feeder 2 - 2.0 |
| P53 | N550:EXP1 = 70:30 | N550: 3.5 | Feeder 1 - 7.0 |
| | | EXP1: 1.5 | Feeder 2 - 3.0 |
| P54 | N550:EXP1 = 50:50 | N550: 2.5 | Feeder 1 - 5.0 |
| | | EXP1: 2.5 | Feeder 2 - 5.0 |
| P61 | N550:EXP2 = 50:50 | N550: 2.5 | Feeder 1 - 5.0 |
| | | EXP2: 2.5 | Feeder 2 - 5.0 |
| P62 | EXP2 = 100 | N550: 0 | Feeder 1 - 0.0 |
| | | EXP2: 5.0 | Feeder 2 - 10.0 |
| P64 | EXP3 = 100 | N774: 0 | Feeder 1 - 0 |
| | | EXP3: 5.0 | Feeder 2 - 10. |

Filler 1-N339, N660, N134, N234, N550, N774; Filler 2- EXP1, EXP2, EXP3;
Feeding time 30 min.

In the present invention, a first carbon black, ‘filler 1’ is selected from conventional hard and soft grade carbon black of N100, N200, N300, N500, N600, N700 series or chemically treated, preferably coupling agent treated, organic group containing or sulfur containing compound treatedcarbon black of N100, N200, N300, N500, N600 and N700 series.

The carbon black composition grade of ‘filler 1’ and ‘filler 2’ can also be made using any other conventional filler mixing techniques followed by granulation, including a granulator using suitable quantity of water, molasses, or sugar solutions as binders.

The carbon black composition grade comprising ‘filler 1’ and ‘filler 2’ is preferably prepared inside a drum shaped blender of maximum volume capacity of 10 liters with the options of two entry locations of the carbon black to be used to prepare carbon black composition grade and one discharge location at the bottom of the blender followed by granulation. The options for attaching agitators, like paddles or ribbon are there inside the blender. However, to avoid breakage of carbon black pellets due to intensive shear force with agitators, the carbon black composition comprising ‘filler 1’ and ‘filler 2’ is prepared under convection force preferably by 360° tumbling with sequential clockwise and anti-clockwise movement. The other blenders, such as ‘V’ blender, double cone blender, granulator and milling process can also be used for preparing the present carbon black composition grade.

In case, when carbon black composition is prepared from carbon black powders, ribbon blender, paddle blender, granulator or plough shear mixer of any capacity can also be used for preparing the present carbon black composition grade.

The drum blender can be filled up through two entry locations present at the top of the blender with predefined weight of carbon blacks manually and finally mixed the carbon black by 360° rotating actions of the blender, sequential clockwise and anti-clockwise rotations for a predetermined time period of 12 hours of less, 6 hours of less, from about 5 minutes to about 6 hours or any other predetermined time in between at an rpm from about 100 to about 200, from about 10 to 100.

The blender can also be filled with predefined weight of carbon blacks through two loss in weight feeders above the two entry locations of the blender under vibration mode, where one feeder is feeding one first carbon black, ‘filler 1’, and the other feeder is feeding one second carbon black, ‘filler 2’. When total 5 kg of one first carbon black, ‘filler 1’, and one second carbon black, ‘filler 2’ are incorporated inside the blender, the feeder stops feeding the fillers inside the blender and the openings of the entry locations are closed and the ‘filler 1’ and ‘filler 2’ were mixed by 360° tumbling rotation of the blender with sequential clockwise and anti-clockwise rotations for a predetermined time period of 12 hours of less, 6 hours of less, from about 5 minutes to about 6 hours or any other predetermined time in between at an rpm from about 100 to about 200, or from about 10 to 100.

The carbon black composition grade and granules can be made in a granulator comprising a principal rotor and a chopper capable of rotating at different rotating speed. The predefined carbon black composition, table 1, is introduced inside the granulator with required amount of water, molasses or sugar solution and granulated for at least 15 minutes to make the granules.

The carbon black composition grade and granules can be further made in process during carbon black manufacturing by incorporating filler 1 and filler 2 inside the pelletizer in presence of water and a binder solution such as, molasses, sugar, ligno-sulfonate etc. followed by drying process.

### Example 1

Preparation of P23: The sample P23 of 5 kg batch is made by feeding the carbon black pellet, of one first carbon black, ‘filler 1’, N339, from feeder 1 and one second carbon black, ‘filler 2’, EXP1, from feeder 2 at a feed rate of 9.5 kg/h and 0.5 kg/h respectively inside the drum blender for 30 min through two entry locations of the blender. After 30 min, the feeder is switched off and the two entry locations of the blender are closed with the lid. The carbon blacks added are mixed in the blender by tumbling the blender chamber at 360° rotation sequentially in clockwise direction and then in anticlockwise direction for 5 min. at about 25 rpm to about 50 rpm. After 5 min, the carbon black composition is stored in a closed aluminum container for further use in developing elastomer compounds.

### Example 2 to Example 10

Preparation of P24 to P33: The samples P24 to P33 each of 5 kg batch are made by adopting the same process described in example 1 above and following the carbon black composition, amount of carbon black in kg and feed rate kg/h disclosed in Table 1. The carbon black compositions are stored in a closed aluminum container for further use in developing elastomer compounds.

### Example 11, Example 13 and Example 14

Preparation of P36, P37 and P58: The samples P36, P37 and P58 each of 5 kg batch are made by adopting the same process described in example 1 above and following the carbon black composition, amount of carbon black in kg and feed rate kg/h disclosed in table 1. The carbon black compositions are stored in a closed aluminum container for further use in developing elastomer compounds.

### Example 15 to Example 17

Preparation of P39, P40 and P48: The sample P39, P40 and P48 each of 5 kg batch are made by adopting the same process described in example 1 above and following the carbon black composition, amount of carbon black in kg and feed rate kg/h disclosed in table 1. The carbon black compositions are stored in a closed aluminum container for further use in developing elastomer compounds.

### Example 18 to Example 21

Preparation of P42 to P44 and P63: The samples P42 to P44 and P63 each of 5 kg batch are made by adopting the same process described in example 1 above and following the carbon black composition, amount of carbon black in kg and feed rate kg/h disclosed in table 1. The carbon black compositions are stored in a closed aluminum container for further use in developing elastomer compounds.

### Example 22 to Example 24

Preparation of P52 to P54 and P61: The sample P52 to P54 and P61, each 5 kg batch are made by adopting the same process described in example 1 above and following the carbon black composition, amount of carbon black in kg and feed rate kg/h disclosed in table 1. The carbon black compositions are stored in a closed aluminum container for further use in developing elastomer compounds.

### Comparative Example 1 to Example 9

Preparation of P22, P28, P32, P35, P38, P41 and P51, P62, and P64: The sample P22, P28, P32, P35, P38, P41 and P51, P62, and P64 ‘each of 5 kg batch are made by adopting the same process described in example 1 above and following the carbon black composition, amount of carbon black in kg and feed rate kg/h disclosed in table 1. The carbon black compositions are stored in a closed aluminum container for further use in developing elastomer compounds.

Preparation of Elastomer Compounds

When an elastomer compound is manufactured, the carbon black composition grade is prepared separately and then introduced with one or more additives into the rubber that form the elastomer compound after vulcanization or curing.

In this invention, the raw rubber is defined as rubber and vulcanized or cured rubber is defined as elastomer compound.

The carbon black of predefined composition is prepared using one first carbon black, ‘filler 1’, with iodine adsorption number in the range of about 25 to 160 mg/g, preferably, in the range of about 40 to 150 mg/g; nitrogen surface area (NSA) in the range of 20 to 150 m²/g, preferably, in the range of 35 to 140 m²/g; oil absorption number (OAN) in the range of 70 to 140 ml/100 g, more preferably, in the range of 80 to 125 ml/100 g with at least one second carbon black, filler 2, preferably, with iodine number in the range of 160 to 300 mg/g, nitrogen surface area (NSA) in the range of 160 to 300 m²/g; oil absorption number (OAN) in the range of 50 to 120 ml/100 g, is compounded with predefined rubber, wherein, the content of carbon black composition in the elastomer compound is in the range of about 0.05 phr to 200 phr.

Other compounding ingredients and the formulation of different rubber compounds are shown in Table 2, Table 3, Table 4, Table 5 and Table 6.

TABLE 2
Formulation of Rubber Compounds (NR/BR) *

| Component | P22C | P23C | P24C | P25C | P26C | P27C | P28C | P29C | P30C |
|---|---|---|---|---|---|---|---|---|---|
| NR | 50 | 50 | 50 | 50 | 50 | 50 | 50 | 50 | 50 |
| BR | 50 | 50 | 50 | 50 | 50 | 50 | 50 | 50 | 50 |
| N339 | 45 | 42.75 | 40.5 | 38.25 | 36 | 33.75 | 0 | 31.5 | 27 |
| EXP1 | 0 | 2.25 | 4.5 | 6.75 | 9 | 11.25 | 45 | 13.5 | 18 |
| N134 | 0 | 0 | 0 | 0 | 0 | 0 | 0 | 0 | 0 |
| N234 | 0 | 0 | 0 | 0 | 0 | 0 | 0 | 0 | 0 |
| N660 | 0 | 0 | 0 | 0 | 0 | 0 | 0 | 0 | 0 |
| ZnO | 6 | 6 | 6 | 6 | 6 | 6 | 6 | 6 | 6 |
| Peptizer | 0.05 | 0.05 | 0.05 | 0.05 | 0.05 | 0.05 | 0.05 | 0.05 | 0.05 |
| Oil | 6 | 6 | 6 | 6 | 6 | 6 | 6 | 6 | 6 |
| Stearic Acid | 2 | 2 | 2 | 2 | 2 | 2 | 2 | 2 | 2 |
| TMQ | 1.5 | 1.5 | 1.5 | 1.5 | 1.5 | 1.5 | 1.5 | 1.5 | 1.5 |
| Wax | 2 | 2 | 2 | 2 | 2 | 2 | 2 | 2 | 2 |
| 6PPD | 3 | 3 | 3 | 3 | 3 | 3 | 3 | 3 | 3 |
| CBS | 1.3 | 1.3 | 1.3 | 1.3 | 1.3 | 1.3 | 1.3 | 1.3 | 1.3 |
| Sulfur | 1.44 | 1.44 | 1.44 | 1.44 | 1.44 | 1.44 | 1.44 | 1.44 | 1.44 |
| Retarder (PVI) | 0.15 | 0.15 | 0.15 | 0.15 | 0.15 | 0.15 | 0.15 | 0.15 | 0.15 |

Formulation of Rubber Compounds *

| Component | P35C | P36C | P37C | P38C | P39C | P40C |
|---|---|---|---|---|---|---|
| NR | 50 | 50 | 50 | 50 | 50 | 50 |
| BR | 50 | 50 | 50 | 50 | 50 | 50 |
| N134 | 45 | 22.5 | 36 | 0 | 0 | 0 |
| N660 | 0 | 0 | 0 | 45 | 22.5 | 36 |
| EXP1 | 0 | 22.5 | 9 | 0 | 22.5 | 9 |
| ZnO | 6 | 6 | 6 | 6 | 6 | 6 |
| Peptizer | 0.05 | 0.05 | 0.05 | 0.05 | 0.05 | 0.05 |
| Oil | 6 | 6 | 6 | 6 | 6 | 6 |
| Stearic Acid | 2 | 2 | 2 | 2 | 2 | 2 |
| TMQ | 1.5 | 1.5 | 1.5 | 1.5 | 1.5 | 1.5 |
| Wax | 2 | 2 | 2 | 2 | 2 | 2 |
| 6PPD | 3 | 3 | 3 | 3 | 3 | 3 |
| CBS | 1.3 | 1.3 | 1.3 | 1.3 | 1.3 | 1.3 |
| Sulfur | 1.44 | 1.44 | 1.44 | 1.44 | 1.44 | 1.44 |
| Retarder (PVI) | 0.15 | 0.15 | 0.15 | 0.15 | 0.15 | 0.15 |

* The amount of rubber and rubber ingredients are in phr.

The masterbatch of each elastomer compounds described in Table 2 are made by compounding predefined amount of carbon black composition and other additives, except sulphur, CBS and retarder (PVI)), in a Banbury mixer for 4 minutes, and rotor speed of about 60 rpm to about 75 rpm. The carbon black mixed with rubber and other compounding ingredients was further milled in a two-roll mill to form a masterbatch sheet, which is kept at room temperature for at least 24 hours.

After 24 hours, the masterbatch is mixed with the curing ingredients (sulphur, CBS and retarder) in a Banbury mixer for 1.5 minutes at a rotor speed of about 30 rpm to about 40 rpm. The compound from the banbury mixer was milled in two roll mill to homogenize and to prepare the rubber sheet.

The compositions of elastomer compounds are shown in Table 2.

### Example 26

Preparation of P23C: The elastomer compound ‘P23C’ is made by adopting the following methods. To prepare ‘P23C’, the carbon black composition, ‘P23’ of 271.8 gram containing 258.23 gram of one first carbon black, filler 1, N339, and 13.59 gram of one second carbon black, filler 2, EXP1 was used.

Preparation of Masterbatch

About 302.02 gram of natural rubber (NR) is compounded inside a banbury mixer for about 15 second to about 20 second followed by addition of about 302.02 gram of butadiene rubber (BR) inside the banbury mixer and continues the compounding process for another about 15 second toabout 20 second. Subsequently about 135.9 gram of ‘P23’ carbon black composition is added in the rubber inside the banbury mixer along with different additives, like, ZnO 36.24 gram, peptizer 0.30 gram, stearic acid 12.08 gram, TMQ 9.06 gram, wax 12.08 gram, 6PPD 18.12 gram and the total mass is compounded for about 20 second to about 30 second. The remaining about 135.9 gram of ‘P23’ carbon black composition is added in the compounded mass inside the banbury mixer along with the oil, 36.24 gram, and continues compounding till completion of 4 minute from the initiation of the compounding process.

The compounding in the banbury mixer is carried out at a rotor speed about 60 rpm to about 75 rpm, preferably at a rotor speed of 65 rpm to about 70 rpm.

After completion of 4 minutes of compounding, the masterbatch is collected at a dump temperature of masterbatch compound of about 145° to 155° C. from the banbury mixer and milled in a two roll mill to form a rubber sheet and kept at 25° C. for at least 24 hour.

Preparation of Final Elastomer Compound

835 gram of masterbatch sample is compounded at a temperature range of about 90° C. to about 110° C., with sulphur 7.27 gram, CBS 6.56 gram and PVI 0.76 gram in a banbury mixture for about 2.5 minute to about 1.5 minute, at a rotor speed of about 30 rpm to about 40 rpm.

The compound from the banbury mixer was milled in two roll mill to homogenize.

### Example 27

Preparation of P24C: The elastomer compound ‘P24C’ is made by adopting the following methods: The carbon black composition, ‘P24’, wherein 271.8 gram of the same is obtained by mixing 244.64 gram of one first carbon black, filler 1, N339, and 27.18 gram of one second carbon black, filler 2, EXP1.

The masterbatch and final rubber compound of example 27 are made by adopting the same method described for example 26.

### Example 28

Preparation of P25C: The elastomer compound ‘P25C’ is made by adopting the following methods.

The carbon black composition, ‘P25’ wherein 271.8 gram of the same is obtained by mixing 231.05 gram of one first carbon black, filler 1, N339, and 40.77 gram of one second carbon black, filler 2, EXP1.

The masterbatch and final rubber compound of example 28 are made by adopting the same method described for example 26.

### Example 29

Preparation of P26C: The elastomer compound ‘P26C’ is made by adopting the following methods.

The carbon black composition, ‘P26’ wherein 271.8 gram of the same is obtained by mixing 217.46 gram of one first carbon black, filler 1, N339, and 54.36 gram of one second carbon black, filler 2, EXP1.

The masterbatch and final rubber compound of example 29 are made by adopting the same method described for example 26.

### Example 30

Preparation of P27C: The elastomer compound ‘P27C’ is made by adopting the following methods.

The carbon black composition, ‘P27’ wherein 271.8 gram of the same is obtained by mixing 203.87 gram of one first carbon black, filler 1, N339, and 67.96 gram of one second carbon black, filler 2, EXP1.

The masterbatch and final rubber compound of example 30 are made by adopting the same method described for example 26.

### Example 3l

Preparation of P29C: The elastomer compound ‘P29C’ is made by adopting the following methods.

The carbon black composition, ‘P29’ wherein 271.8 gram of the same is obtained by mixing 190.27 gram of one first carbon black, filler 1, N339, and 81.55 gram of one second carbon black, filler 2, EXP1.

The masterbatch and final rubber compound of example 31 are made by adopting the same method described for example 26.

### Example 32

Preparation of P30C: The elastomer compound ‘P30C’ is made by adopting the following methods.

The carbon black composition, ‘P30’ wherein 271.8 gram of the same is obtained by mixing 163.09 gram of one first carbon black, filler 1, N339, and 108.73 gram of one second carbon black, filler 2, EXP1.

The masterbatch and final rubber compound of example 32 are made by adopting the same method described for example 26.

### Example 33

Preparation of P31C: The elastomer compound ‘P31C’ is made by adopting the following methods.

The carbon black composition, ‘P31’ wherein 271.8 gram of the same is obtained by mixing 135.91 gram of one first carbon black, filler 1, N339, and 135.9 gram of one second carbon black, filler 2, EXP1.

The masterbatch and final rubber compound of example 33 are made by adopting the same method described for example 26.

### Example 34

Preparation of P36C: The elastomer compound ‘P36C’ is made by adopting the following methods.

The carbon black composition, ‘P36’ wherein 271.8 gram of the same is obtained by mixing 135.91 gram of one first carbon black, filler 1, N134, and 135.9 gram of one second carbon black, filler 2, EXP1.

The masterbatch and final rubber compound of example 34 are made by adopting the same method described for example 26.

### Example 35

Preparation of P37C: The elastomer compound ‘P37C’ is made by adopting the following methods.

The carbon black composition, ‘P37’ wherein 271.8 gram of the same is obtained by mixing 217.46 gram of one first carbon black, filler 1, N134, and 54.36 gram of one second carbon black, filler 2, EXP1.

The masterbatch and final rubber compound of example 35 are made by adopting the same method described for example 26.

### Example 36

Preparation of P39C: The elastomer compound ‘P39C’ is made by adopting the following methods.

The carbon black composition, ‘P39’ wherein 271.8 gram of the same is obtained by mixing 135.91 gram of one first carbon black, filler 1, N660, and 135.9 gram of one second carbon black, filler 2, EXP1.

The masterbatch and final rubber compound of example 36 are made by adopting the same method described for example 26.

### Example 37

Preparation of P40C: The elastomer compound ‘P40C’ is made by adopting the following methods.

The carbon black composition, ‘P40’ wherein 271.8 gram of the same is obtained by mixing 217.46 gram of one first carbon black, filler 1, N660, and 135.9 gram of one second carbon black, filler 2, EXP1.

The masterbatch and final rubber compound of example 37 are made by adopting the same method described for example 26.

### Comparative Example 10

Preparation of P38C: The elastomer compound ‘P38C’ is made by adopting the following methods.

The carbon black composition, ‘P38’ wherein 271.8 gram of the same is obtained by mixing 271.8 gm of one first carbon black, filler 1 N660 and 0.0 gm of the second carbon black, filler 2, EXP 1.

The masterbatch and final rubber compound of comparative example 10 are made by adopting the same method described for example 26.

### Comparative Example 11

Preparation of P28C: The elastomer compound ‘P28C’ is made by adopting the following methods.

The carbon black composition, ‘P28’ wherein 271.8 gram of the same is obtained by mixing 271.8 gram of one second carbon black, filler 2, EXP 1, and 0.0 gram of one first carbon black, filler 1, N339.

The masterbatch and final rubber compound of example 11 are made by adopting the same method described for example 26.

TABLE 3
Formulation of Rubber Compounds (SBR/BR) *

| Component | P56C | P57C | P58C | P59C | P60C |
|---|---|---|---|---|---|
| SBR1712 | 96.25 | 96.25 | 96.25 | 96.25 | 96.25 |
| BR | 30 | 30 | 30 | 30 | 30 |
| N134 | 60 | 48 | 42 | 30 | 0 |
| EXP1 | 0 | 12 | 18 | 30 | 60 |
| ZnO | 3 | 3 | 3 | 3 | 3 |
| Stearic Acid | 2 | 2 | 2 | 2 | 2 |
| TMQ | 1 | 1 | 1 | 1 | 1 |
| Sulphur | 1.5 | 1.5 | 1.5 | 1.5 | 1.5 |
| CBS | 1.2 | 1.2 | 1.2 | 1.2 | 1.2 |
| Retarder | 0.2 | 0.2 | 0.2 | 0.2 | 0.2 |
| (PVI) | | | | | |

* The amount of rubber and rubber ingredients are in phr.

The masterbatch of each elastomer compound described in Table 3 are made by compounding predefined amount of carbon black composition and other additives, except sulphur, CBS and retarder (PVI)), in a banbury mixer for 4 minutes, and rotor speed of about 60 rpm to about 75 rpm. The carbon black mixed with rubber and other compounding ingredients was further milled in a two roll mill to form a masterbatch sheet, which is kept at room temperature for at least 24 hours.

After 24 hours, the masterbatch is mixed with the curing ingredients (sulphur, CBS and retarder) in a banbury mixer for 1.5 minutes at a rotor speed of about 30 rpm to about 40 rpm. The compound from the banbury mixer was milled in two roll mill to homogenize and to prepare the rubber sheet.

The compositions of elastomer compounds are shown in Table 3.

### Example 38

Preparation of P57C: The elastomer compound ‘P57C’ is made by adopting the following methods. To prepare ‘P57C’, the carbon black composition, ‘P37’ of 312.1 gram containing 249.7 gram of one first carbon black, filler 1, N134, and 62.4 gram of one second carbon black, filler 2, EXP1 was used.

Preparation of Masterbatch

About 500 gram of styrene butadiene rubber (SBR) is compounded inside a banbury mixer for about 15 second to about 20 second followed by addition of about 156.0 gram of butadiene rubber (BR) inside the banbury mixer and continues the compounding process for another about 15 second toabout 20 second. Subsequently about 156.05 gram of ‘P37’ carbon black composition is added in the rubber inside the banbury mixer along with different additives, like, ZnO15.6-gram, stearic acid 10.4 gram, TMQ 5.2 gram and the total mass is compounded for about 20 second to about 30 second. The remaining about 156.05 gram of ‘P37’ carbon black composition is added in the compounded mass inside continues compounding till completion of 4 minute from the initiation of the compounding process.

The compounding in the banbury mixer is carried out at a rotor speed about 60 rpm to about 75 rpm, preferably at a rotor speed of 65 rpm to about 70 rpm.

After completion of 4 minutes of compounding, the masterbatch is collected at a dump temperature of masterbatch compound of about 145° to 155° C. from the banbury mixer and milled in a two-roll mill to form a rubber sheet and kept at 25° C. for at least 24 hour.

Preparation of Final Elastomer Compound

835 gram of masterbatch sample is compounded at a temperature range of about 90° C. to about 110° C., with Sulphur 6.5 gram, CBS 5.2 gram and PVI 0.9 gram in a banbury mixture for about 1.5 minute to about 2.5 minute, at a rotor speed of about 30 rpm to about 40 rpm.

The compound from the banbury mixer was milled in two roll mill to homogenize.

### Example 39

Preparation of P58C: The elastomer compound ‘P58C’ is made by adopting the following methods:

The carbon black composition, ‘P58’, wherein 312.1 gram of the same is obtained by mixing 218.5 gram of one first carbon black, filler 1, N134, and 93.6 gram of one second carbon black, filler 2, EXP1.

The masterbatch and final rubber compound of example 39 are made by adopting the same method described for example 38.

### Example 40

Preparation of P59C: The elastomer compound ‘P59C’ is made by adopting the following methods.

The carbon black composition, ‘P36’ wherein 312.1 gram of the same is obtained by mixing 156.0 gram of one first carbon black, filler 1, N134, and 156.0 gram of one second carbon black, filler 2, EXP1.

The masterbatch and final rubber compound of example 40 are made by adopting the same method described for example 38.

### Comparative Example 12

Preparation of P60C: The elastomer compound ‘P60C’ is made by adopting the following methods.

The carbon black composition, ‘P28’ wherein 312.1 gram of the same is obtained by mixing 0 gm of one first carbon black, filler 1 N134 and 312.1 gm of the second carbon black, filler 2, EXP 1.

The masterbatch and final rubber compound of comparative example 12 are made by adopting the same method described for example 38.

TABLE 4
Formulation of Rubber Compounds(IIR)*

| Component | P41C | P42C | P43C | P44C | P45C | P63C | P64C |
|---|---|---|---|---|---|---|---|
| IIR | 100 | 100 | 100 | 100 | 100 | 100 | 100 |
| N774 | 70 | 56 | 49 | 35 | 0 | 35 | 0 |
| EXP1 | 0 | 14 | 21 | 35 | 70 | 0 | 0 |
| EXP3 | 0 | 0 | 0 | 0 | 0 | 35 | 70 |
| Paraffinic oil | 25 | 25 | 25 | 25 | 25 | 25 | 25 |
| Stearic Acid | 1 | 1 | 1 | 1 | 1 | 2 | 2 |
| ZnO | 5 | 5 | 5 | 5 | 5 | 5 | 5 |
| MBT | 0.5 | 0.5 | 0.5 | 0.5 | 0.5 | 0.5 | 0.5 |
| TMTD | 1.5 | 1.5 | 1.5 | 1.5 | 1.5 | 1.5 | 1.5 |
| Sulfur | 2 | 2 | 2 | 2 | 2 | 2 | 2 |

*The amount of rubber and rubber ingredients are in phr.

The masterbatch of each elastomer compound described in Table 4 are made by compounding predefined amount of carbon black composition and other additives, except sulphur, TMTD and MBT, in a banbury mixer for 4 minutes, and rotor speed of about 60 rpm to about 75 rpm. The carbon black mixed with rubber and other compounding ingredients was further milled in a two roll mill to form a masterbatch sheet, which is kept at room temperature for at least 24 hours.

After 24 hours, the masterbatch is mixed with the curing ingredients (sulphur, TMTD and MBT) in a banbury mixer for 2.5 minutes at a rotor speed of about 30 rpm to about 40 rpm. The compound from the banbury mixer was milled in two roll mill to homogenize and to prepare the rubber sheet.

The compositions of elastomer compounds are shown in Table 4.

### Example 4l

Preparation of P42C: The elastomer compound ‘P42C’ is made by adopting the following methods. To prepare ‘P42C’, the carbon black composition, ‘42’ of 348.3 gram containing 278.6 gram of one first carbon black, filler 1, N774, and 69.7 gram of one second carbon black, filler 2, EXP1 was used.

Preparation of Masterbatch

About 300 gram of butyl (IIR) is compounded inside a banbury mixer for about 15 second to about 20 second followed by addition of about 197.5 gram of rest butyl rubber inside the banbury mixer and continues the compounding process for another about 15 second toabout 20 second. Subsequently about 174.15 gram of ‘P42’ carbon black composition is added in the rubber inside the banbury mixer along with different additives, like, ZnO24.9-gram, stearic acid 5.0 gram and the total mass is compounded for about 20 second to about 30 second. The remaining about 174.15 gram of ‘P37’ carbon black composition is added with 124.4 gram of paraffinic oil in the compounded mass inside continues compounding till completion of 4 minute from the initiation of the compounding process.

The compounding in the banbury mixer is carried out at a rotor speed about 60 rpm to about 75 rpm, preferably at a rotor speed of 65 rpm to about 70 rpm.

After completion of 4 minutes of compounding, the masterbatch is collected at a dump temperature of masterbatch compound of about 145° to 155° C. from the banbury mixer and milled in a two-roll mill to form a rubber sheet and kept at 25° C. for at least 24 hour.

Preparation of Final Elastomer Compound

835 gram of masterbatch sample is compounded at a temperature range of about 90° C. to about 110° C., with Sulphur 8.3 gram, MBT2.1 gram and TMTD6.2 gram in a banbury mixture for about 1.5 minute to about 2.5 minute, at a rotor speed of about 30 rpm to about 40 rpm.

The compound from the banbury mixer was milled in two roll mill to homogenize

### Example 42

Preparation of P43C: The elastomer compound ‘P43C’ is made by adopting the following methods:

The carbon black composition, ‘P43’, wherein 348.3 gram of the same is obtained by mixing 244.0 gram of one first carbon black, filler 1, N774, and 104.6 gram of one second carbon black, filler 2, EXP1.

The masterbatch and final rubber compound of example 42 are made by adopting the same method described for example 41.

### Example 43

Preparation of P44C: The elastomer compound ‘P44C’ is made by adopting the following methods.

The carbon black composition, ‘P44’ wherein 348.3 gram of the same is obtained by mixing 174.15 gram of one first carbon black, filler 1, N774, and 174.15 gram of one second carbon black, filler 2, EXP1.

The masterbatch and final rubber compound of example 43 are made by adopting the same method described for example 41.

### Example 44

Preparation of P63C: The elastomer compound ‘P63C’ is made by adopting the following methods.

The carbon black composition, ‘P63’ wherein 348.3 gram of the same is obtained by mixing 174.15 gram of one first carbon black, filler 1, N774, and 174.15 gram of one second carbon black, filler 2, EXP3.

The masterbatch and final rubber compound of example 44 are made by adopting the same method described for example 41.

### Comparative Example 13

Preparation of P45C: The elastomer compound ‘P45C’ is made by adopting the following methods.

The carbon black composition, ‘P28’ wherein 348.3 gram of the same is obtained by mixing 0 gm of one first carbon black, filler 1 N774 and 348.3 gm of the second carbon black, filler 2, EXP 1.

The masterbatch and final rubber compound of comparative example 13 are made by adopting the same method described for example 41.

### Comparative Example 14

Preparation of P64C: The elastomer compound ‘P64C’ is made by adopting the following methods.

The carbon black composition, ‘P64’ wherein 348.3 gram of the same is obtained by blending 0 gm of one first carbon black, filler 1 N774 and 348.3 gm of the second carbon black, filler 2, EXP 3.

The masterbatch and final rubber compound of comparative example 14 are made by adopting the same method described for example 41.

TABLE 5
Formulation of Rubber Compounds (NBR) *

| Component | P46C | P47C | P48C | P49C | P50C |
|---|---|---|---|---|---|
| NBR | 100 | 100 | 100 | 100 | 100 |
| ZnO | 5 | 5 | 5 | 5 | 5 |
| Stearic Acid | 1.5 | 1.5 | 1.5 | 1.5 | 1.5 |
| TDQ | 1 | 1 | 1 | 1 | 1 |
| N660 | 50 | 40 | 30 | 25 | 0 |
| B219 | 0 | 10 | 20 | 25 | 50 |
| Wax | 1 | 1 | 1 | 1 | 1 |
| DOP oil | 8 | 8 | 8 | 8 | 8 |
| MBTS | 1 | 1 | 1 | 1 | 1 |
| TMT | 1 | 1 | 1 | 1 | 1 |
| Sulfur | 2 | 1 | 1 | 1 | 1 |

* The amount of rubber and rubber ingredients are in phr.

The masterbatch of each elastomer compound described in Table 5 are made by compounding predefined amount of carbon black composition and other additives, except sulphur, TMT and MBTS, in a banbury mixer for 4 minutes, and rotor speed of about 60 rpm to about 75 rpm. The carbon black mixed with rubber and other compounding ingredients was further milled in a two roll mill to form a masterbatch sheet, which is kept at room temperature for at least 24 hours.

After 24 hours, the masterbatch is mixed with the curing ingredients (sulphur, TMT and MBTS) in a banbury mixer for 2.5 minutes at a rotor speed of about 30 rpm to about 40 rpm. The compound from the banbury mixer was milled in two roll mill to homogenize and to prepare the rubber sheet.

The compositions of elastomer compounds are shown in Table 5.

### Example 45

Preparation of P47C: The elastomer compound ‘P47C’ is made by adopting the following methods. To prepare ‘P47C’, the carbon black composition, ‘P40’ of 300.3 gram containing 240.2 gram of one first carbon black, filler 1, N660, and 60.1 gram of one second carbon black, filler 2, EXP1 was used.

Preparation of Masterbatch

About 300 gram of nitrile butadiene rubber (NBR) is compounded inside a banbury mixer for about 15 second to about 20 second followed by addition of about 300.6 gram of rest nitrile butadiene rubber inside the banbury mixer and continues the compounding process for another about 15 second toabout 20 second. Subsequently about 150.3 gram of ‘P40’ carbon black composition is added in the rubber inside the banbury mixer along with different additives, like, ZnO30.0-gram, stearic acid 9.0 gram, TDQ 6.0-gram, paraffinic wax 6.0 gram and the total

mass is compounded for about 20 second to about 30 second. The remaining about 150.0 gram of ‘P40’ carbon black composition is added with 48.0 gram of aromatic oil in the compounded mass inside continues compounding till completion of 4 minute from the initiation of the compounding process.

The compounding in the banbury mixer is carried out at a rotor speed about 60 rpm to about 75 rpm, preferably at a rotor speed of 65 rpm to about 70 rpm.

After completion of 4 minutes of compounding, the masterbatch is collected at a dump temperature of masterbatch compound of about 145° to 155° C. from the banbury mixer and milled in a two-roll mill to form a rubber sheet and kept at 25° C. for at least 24 hour.

Preparation of Final Elastomer Compound

830.1 gram of masterbatch sample is compounded at a temperature range of about 90° C. to about 110° C., with Sulphur 9.97 gram, MBTS4.99 gram and TMT 4.9 gram in a banbury mixture for about 1.5 minute to about 2.5 minute, at a rotor speed of about 30 rpm to about 40 rpm.

The compound from the banbury mixer was milled in two roll mill to homogenize

### Example 46

Preparation of P48C: The elastomer compound ‘P48C’ is made by adopting the following methods:

The carbon black composition, ‘P48’, wherein 300.3 gram of the same is obtained by mixing 180.2 gram of one first carbon black, filler 1, N660, and 120.1 gram of one second carbon black, filler 2, EXP1.

The masterbatch and final rubber compound of example 46 are made by adopting the same method described for example 45.

### Example 47

Preparation of P49C: The elastomer compound ‘P49C’ is made by adopting the following methods.

The carbon black composition, ‘P39’ wherein 300.3 gram of the same is obtained by mixing 150.15 gram of one first carbon black, filler 1, N660, and 150.15 gram of one second carbon black, filler 2, EXP1.

The masterbatch and final rubber compound of example 47 are made by adopting the same method described for example 45.

### Comparative Example 15

Preparation of P50C: The elastomer compound ‘P50C’ is made by adopting the following methods.

The carbon black composition, ‘P28’ wherein 300.3 gram of the same is obtained by mixing 0 gm of one first carbon black, filler 1 N660 and 300.3 gram of the second carbon black, filler 2, EXP 1.

The masterbatch and final rubber compound of comparative example 15 are made by adopting the same method described for example 45.

TABLE 6
Formulation of Rubber Compounds (EPDM) *

| Component | P51C | P52C | P53C | P54C | P55C | P61C | P62C |
|---|---|---|---|---|---|---|---|
| EPDM | 100 | 100 | 100 | 100 | 100 | 100 | 100 |
| ZnO | 5 | 5 | 5 | 5 | 5 | 5 | 5 |
| Stearic Acid | 2 | 2 | 2 | 2 | 2 | 2 | 2 |
| N550 | 150 | 120 | 105 | 75 | 150 | 75 | 0 |
| EXP1 | 0 | 30 | 45 | 75 | 0 | 0 | 0 |
| EXP2 | 0 | 0 | 0 | 0 | 0 | 75 | 150 |
| Paraffinic OIL | 80 | 80 | 80 | 80 | 80 | 80 | 80 |
| Wax | 1 | 1 | 1 | 1 | 1 | 1 | 1 |
| TDQ | 2 | 2 | 2 | 2 | 2 | 2 | 2 |
| MBT | 1.5 | 1.5 | 1.5 | 1.5 | 1.5 | 1.5 | 1.5 |
| ZDBC | 0.8 | 0.8 | 0.8 | 0.8 | 0.8 | 0.8 | 0.8 |
| TMT | 0.8 | 0.8 | 0.8 | 0.8 | 0.8 | 0.8 | 0.8 |
| Sulfur | 1.5 | 1.5 | 1.5 | 1.5 | 1.5 | 1.5 | 1.5 |

* The amount of rubber and rubber ingredients are in phr.

The masterbatch of each elastomer compound described in Table 6 are made by compounding predefined amount of carbon black composition and other additives, except sulphur, TMT and MBT, ZDBC in a banbury mixer for 4 minutes, and rotor speed of about 60 rpm to about 75 rpm. The carbon black mixed with rubber and other compounding ingredients was further milled in a two roll mill to form a masterbatch sheet, which is kept at room temperature for at least 24 hours.

After 24 hours, the masterbatch is mixed with the curing ingredients (sulphur, TMT and MBT and ZDBC) in a banbury mixer for 2.5 minutes at a rotor speed of about 30 rpm to about 40 rpm. The compound from the banbury mixer was milled in two roll mill to homogenize and to prepare the rubber sheet.

The compositions of elastomer compounds are shown in Table 6.

### Example 48

Preparation of P52C: The elastomer compound ‘P52C’ is made by adopting the following methods. To prepare ‘P52C’, the carbon black composition, ‘P52’ of 441.2 gram containing 352.9 gram of one first carbon black, filler 1, N550, and 88.2 gram of one second carbon black, filler 2, EXP1 was used.

Preparation of Masterbatch

About 100 gram of ethylene propylene diene monomer (EPDM) is compounded inside a banbury mixer for about 15 second to about 20 second followed by addition about 241.2 gram of ‘P52’ carbon black composition is added in the rubber inside the banbury mixer along with different additives, like, ZnO14.7-gram, stearic acid 5.9 gram, paraffinic wax 2.9 gram, TDQ 5.9 gram and the total mass is compounded for about 20 second to about 30 second subsequently 194.1 gram of rest EPDM rubber inside the banbury mixer and continues the compounding process for another about 15 second toabout 20 second. The remaining about 200 gram of ‘P52’ carbon black composition is added with 235.3 gram of paraffinic oil in the compounded mass inside continues compounding till completion of 4 minute from the initiation of the compounding process.

The compounding in the banbury mixer is carried out at a rotor speed about 60 rpm to about 75 rpm, preferably at a rotor speed of 65 rpm to about 70 rpm.

After completion of 4 minutes of compounding, the masterbatch is collected at a dump temperature of masterbatch compound of about 145° to 155° C. from the banbury mixer and milled in a two-roll mill to form a rubber sheet and kept at 25° C. for at least 24 hour.

Preparation of Final Elastomer Compound

838.6 gram of masterbatch sample is compounded at a temperature range of about 90° C. to about 110° C., with Sulphur 3.70 gram, MBT3.70 gram and TMT1.97 gram, ZDBC 1.97 gram in a banbury mixture for about 1.5 minute to about 2.5 minute, at a rotor speed of about 30 rpm to about 40 rpm.

The compound from the banbury mixer was milled in two roll mill to homogenize

### Example 49

Preparation of P53C: The elastomer compound ‘P53C’ is made by adopting the following methods:

The carbon black composition, ‘P53’, wherein 441.2 gram of the same is obtained by mixing 308.8 gram of one first carbon black, filler 1, N550, and 132.4 gram of one second carbon black, filler 2, EXP1.

The masterbatch and final rubber compound of example 49 are made by adopting the same method described for example 48.

### Example 50

Preparation of P54C: The elastomer compound ‘P54C’ is made by adopting the following methods.

The carbon black composition, ‘P54’ wherein 441.2 gram of the same is obtained by mixing 220.6 gram of one first carbon black, filler 1, N550, and 220.6 gram of one second carbon black, filler 2, EXP1.

The masterbatch and final rubber compound of example 50 are made by adopting the same method described for example 48.

### Example 5l

Preparation of P61C: The elastomer compound ‘P61C’ is made by adopting the following methods.

The carbon black composition, ‘P61’ wherein 441.2 gram of the same is obtained by mixing 220.6 gram of one first carbon black, filler 1, N550, and 220.6 gram of one second carbon black, filler 2, EXP2.

The masterbatch and final rubber compound of example 51 are made by adopting the same method described for example 48.

### Comparative Example 16

Preparation of P55C: The elastomer compound ‘P55C’ is made by adopting the following methods.

The carbon black composition, ‘P28’ wherein 441.2 gram of the same is obtained by mixing 0 gm of one first carbon black, filler 1 N550 and 441.2 gm of the second carbon black, filler 2, EXP 1.

The masterbatch and final rubber compound of comparative example 16 are made by adopting the same method described for example 48.

### Comparative Example 17

Preparation of P62C: The elastomer compound ‘P62C’ is made by adopting the following methods.

The carbon black composition, ‘P62’ wherein 441.2 gram of the same is obtained by mixing 0 gm of one first carbon black, filler 1 N550 and 441.2 gm of the second carbon black, filler 2, EXP 2.

The masterbatch and final rubber compound of comparative example 17 are made by adopting the same method described for example 48.

It is to be understood that both the foregoing general description and the following detailed description are exemplary and are intended to provide further explanation of the invention as claimed. The advancement according to the present invention is discussed in further detail in relation to the following non-limiting exemplary illustrations wherein.

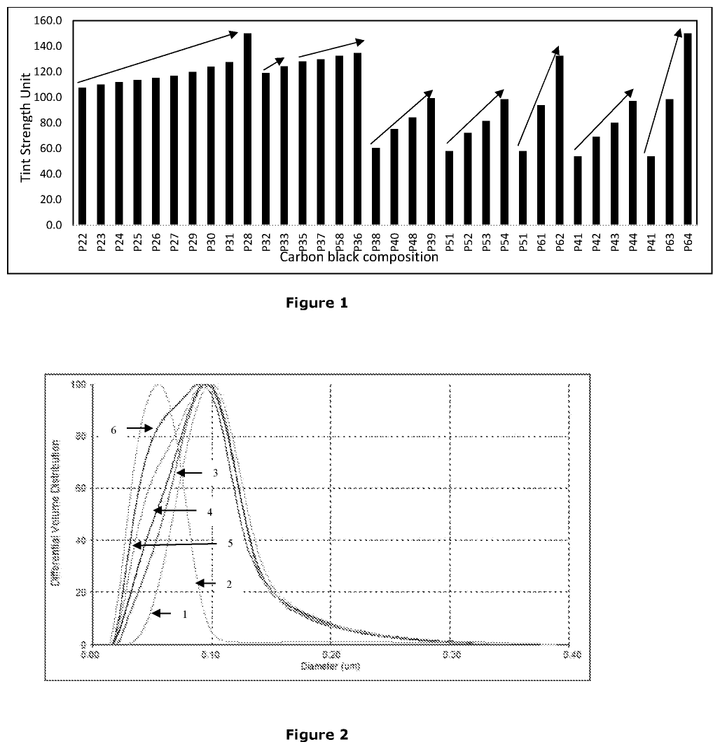

FIG. 1: Tint strength unit of containing carbon black compositions, P22 (N339:EXP1—100:00), P23 (N339:EXP1—95:05), P24 (N339:EXP1—90:10), P25 (N339:EXP1—85:15), P26 (N339:EXP1—80:20), P27 (N339:EXP1—75:25), P29 (N339:EXP1—70:30), P30 (N339:EXP1—60:40), P31 (N339:EXP1—50:50), P28 (N339:EXP1—00:100); P32 (N234:EXP1—100:00), P33 (N234:EXP1—75:25); P35 (N134:EXP1—100:00), P37 (N134:EXP1—80:20), P58 (N134:EXP1—70:30), P36 (N134:EXP1—50:50); P38 (N660:EXP1—100:00), P40 (N660:EXP1—80:20), P48 (N660:EXP1—70:30), P39 (N660:EXP1—50:50); P51 (N550:EXP1—100:00), P52 (N550:EXP1—80:20), P53 (N550:EXP1—70:30), P54m (N550:EXP1—50:50); P61 (N550:EXP2—50:50), P62 (N550:EXP2—00:100); P41 (N774:EXP1—100:00), P42 (N774:EXP1—80:20), P43 (N774:EXP1—70:30), P44C (N774:EXP1—50:50), P63 (N774:EXP3—50:50), P64C (N774:EXP3—00:100).

FIG. 2: Differential volume distribution of aggregate size of (1) P22 (N339:EXP1=100:0.0), (2) P28 (EXP1 100), (3) P26 (N339:EXP1=80:20), (4) P29 (N339:EXP1=70:30), (5) P30 (N339:EXP1=60:40) and (6) P31 (N339:EXP1=50:50).

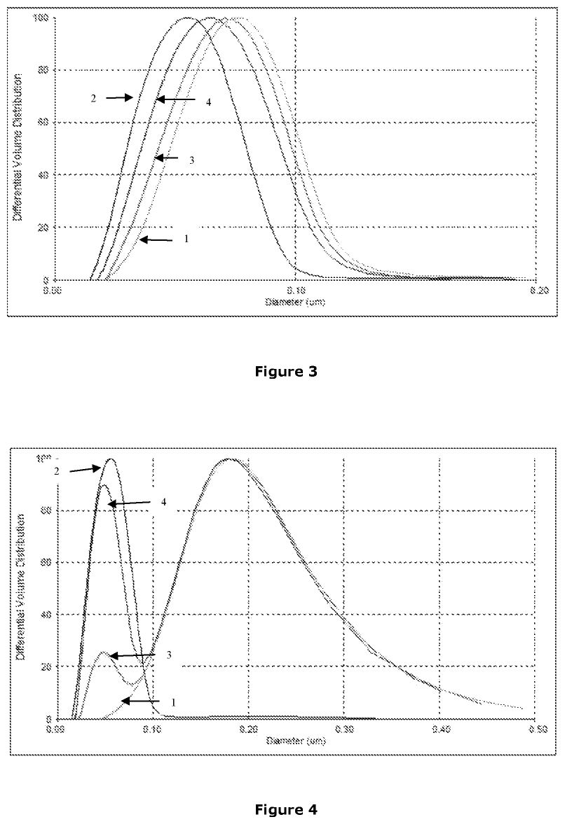

FIG. 3: Differential volume distribution of aggregate size of (1) P35 (N134:EXP1=100:00), (2) P28 (EXP1 100), (3) P37 (N134:EXP1=80:20) and (4) P36 (N134:EXP1=50:50).

FIG. 4: Differential volume distribution of aggregate size of (1) P38 (N660:EXP1=100:00), (2) P28 (EXP1=100), (3) P40 (N660:EXP1=80:20) and (4) P39 (N660:EXP1=50:50).

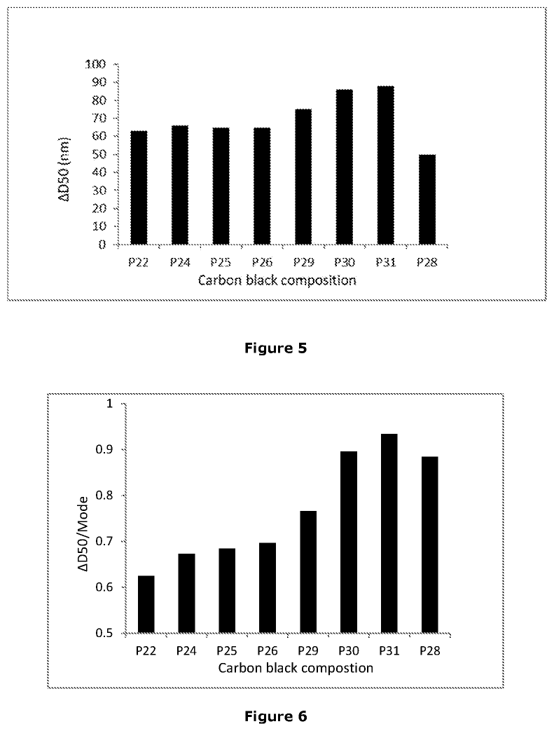

FIG. 5: ΔD50 of carbon black composition P22 (N339:B219=100:00), P24 (N339:B219=90:10), P25 (N339:B219=85:15), P26 (N339:B219=80:20), P29 (N339:B219—70:30), P30 (N339:B219=60:40), P31 (N339:B219=50:50) P28 (B219 100).

FIG. 6: ΔD50/Mode of carbon black composition P22 (N339:B219=100:00), P24 (N339:B219=90:10), P25 (N339:B219=85:15), P26 (N339:B219=80:20), P29 (N339:B219—70:30), P30 (N339:B219=60:40), P31 (N339:B219=50:50) P28 (B219 100).

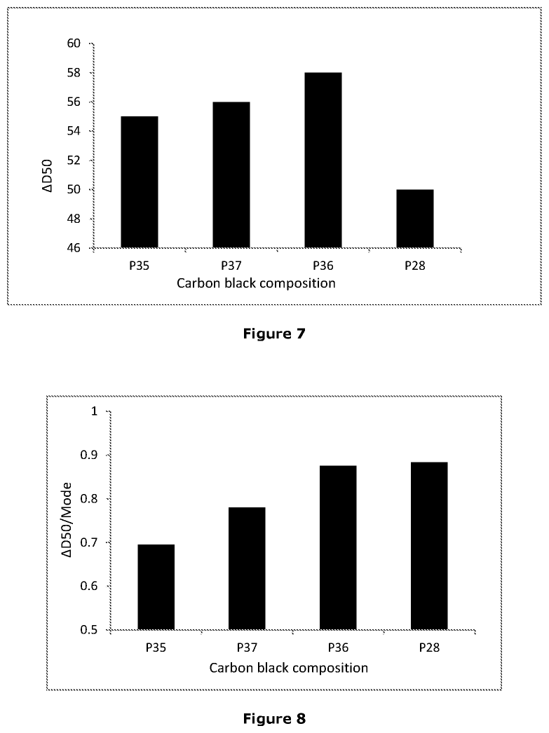

FIG. 7: ΔD50 of carbon black composition P35 (N134:B219=100:00), P37 (N134:B219=80:20), P36 (N134:B219=50:50),) P28 (B219 100).

FIG. 8: ΔD50/Mode of carbon black composition P35 (N134:B219=100:00), P37 (N134:B219=80:20), P36 (N134:B219=50:50),) P28 (B219 100)

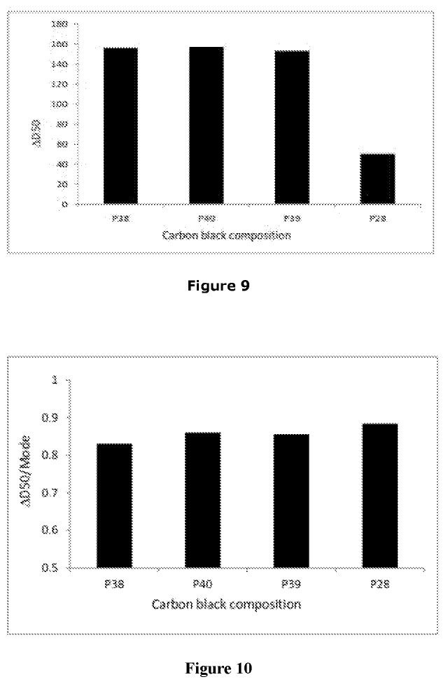

FIG. 9: ΔD50 of carbon black composition P38 (N660:B219=100:00), P28 (B219 100), P40 (N660: B219=80:20) and P39 (N660: B219=50:50).

FIG. 10: ΔD50/Mode of carbon black composition P38 (N660:B219=(100:00), P28 (B219 100), P40 (N660: B219=80:20) and P39 (N660: B219=50:50).

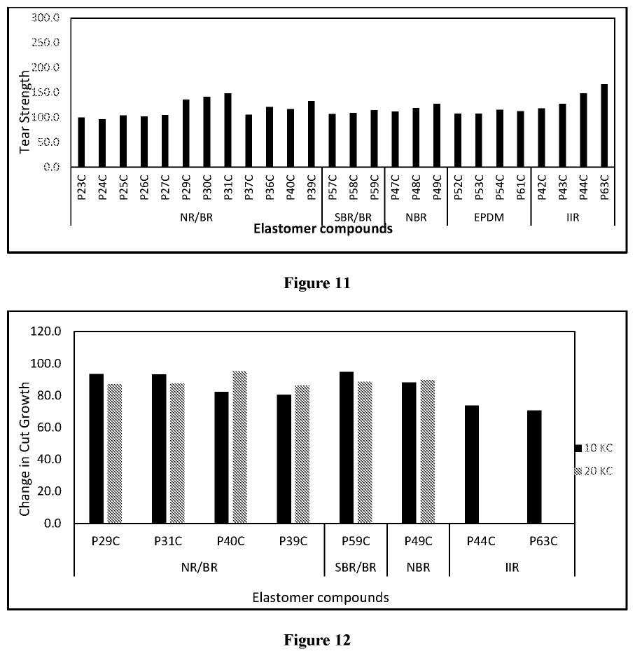

FIG. 11: Tear strength of elastomer compounds containing different carbon black composition, P23C (N339:EXP1—95:05), P24C (N339:EXP1—90:10), P25C (N339:EXP1—85:15), P26C (N339:EXP1—80:20), P27C (N339:EXP1—75:25), P29C (N339:EXP1—70:30), P30C (N339:EXP1—60:40, P31C (N339:EXP1—50:50), P37C (N134:EXP1—80:20), P36C (N134:EXP1—50:50); P40C (N660:EXP1—80:20) P39C (N660:EXP1—50:50); P57C (N134:EXP1—80:20), P58C (N134:EXP1—70:30), P59C (N134:EXP1—50:50), P47C (N660:EXP1—80:20), P48C (N660:EXP1—70:30), P49C (N660:EXP1—50:50) P50C (N660:EXP1—00:100); P52C (N550:EXP1—80:20), P53C (N550:EXP1—70:30), P54C (N550:EXP1—50:50), P61C (N550:EXP2—50:50), P62C (P42C (N774:EXP1—80:20), P43C (N774:EXP1—70:30), P44C (N774:EXP1—50:50), P63C (N774:EXP3—50:50).

FIG. 12: Change in cut growth of various elastomer compounds containing different carbon black composition, P29C (N339:EXP1—70:30), P31C (N339:EXP1—50:50); P40C (N339:EXP1—80:20), P39C (N660:EXP1—50:50); P59C (N134:EXP1—50:50); P49C (N660:EXP1—50:50); P44C (N774:EXP1—50:50), P63C (N774:EXP3—50:50)

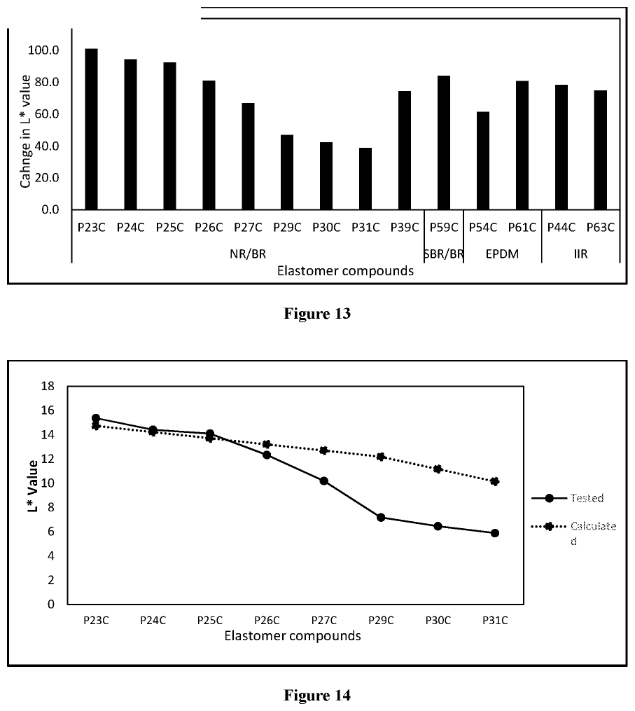

FIG. 13: Change in L* value of elastomer compounds containing different carbon black composition, P23C (N339:EXP1—95:05), P24C (N339:EXP1—90:10), P25C (N339:EXP1—85:15), P26C (N339:EXP1—80:20), P27C (N339:EXP1—75:25) P29C (N339:EXP1—70:30), P30C (N339:EXP1—60:40) P31C (N339:EXP1—50:50); P39C (N660:EXP1—50:50); P59C (N134:EXP1—50:50); P54C (N550:EXP1—50:50), P61C (N550:EXP2—50:50); P44C (N774:EXP1—50:50), P63C (N774:EXP3—50:50).

FIG. 14: Tested and calculated L* value of elastomer compounds containing of different carbon black composition, P23C (N339:EXP1—95:05), P24C (N339:EXP1—90:10), P25C (N339:EXP1-85:15), P26C (N339:EXP1—80:20), P27C (N339:EXP1—75:25) P29C (N339:EXP1—70:30), P30C (N339:EXP1—60:40), and P31C (N339:EXP1—50:50).

Colloidal Properties of Carbon Black Composition Grade

The colloidal properties of carbon black composition, containing one first carbon black, filler 1, and one second carbon black, filler 2, such as, iodine adsorption number (mg/g), nitrogen surface area (NSA, m²/g), statistical surface area (STSA, m²/g), oil absorption number (1AN, ml/100 g), compressed oil absorption number (COAN, ml/100 g), tint strength unit measured by adopting ASTM standard, ASTM D1510, ASTM D6556, ASTM D2414, ASTM D3493 and ASTM D3265, are shown in Table 7, Table 8 and Table 9.

The changes in tint strength of carbon black composition containing different amount of one second carbon black, filler 2, in one first carbon black, filler 1, is shown in FIG. 1.

TABLE 7
Colloidal Properties of Carbon BlackComposition (N339 based)

| Colloidal Property | P22 | P23 | P24 | P25 | P26 | P27 | P28 | P29 | P30 | P31 |
|---|---|---|---|---|---|---|---|---|---|---|
| Iodine | 89.00 | 96.70 | 108.75 | 116.40 | 129.50 | 134.75 | 256.75 | 144.25 | 164.75 | 182.10 |
| adsorption | | | | | | | | | | |
| number(mg/g) | | | | | | | | | | |
| Nitrogen | 86.20 | 92.30 | 103.10 | 109.7 | 121.5 | 128.50 | 262.98 | 137.48 | 152.92 | 171.8 |
| surface area | | | | | | | | | | |
| (NSA) m2/g | | | | | | | | | | |
| Statistical | 85.30 | 91.90 | 99.40 | 104.2 | 112.1 | 121.20 | 208.22 | 124.48 | 138.10 | 148.4 |
| surface area | | | | | | | | | | |
| (STSA) m2/g | | | | | | | | | | |
| Oil absorption | 119.8 | 119.4 | 119.2 | 118.1 | 117.5 | 116.4 | 94.8 | 112.9 | 110.5 | 108.2 |
| number OAN | | | | | | | | | | |
| (ml/100 g) | | | | | | | | | | |
| Compressed | 94.6 | 94.1 | 92.5 | 90.3 | 89.2 | 88.9 | 83.2 | 88.6 | 87.3 | 86.0 |
| Oil absorption | | | | | | | | | | |
| number OAN | | | | | | | | | | |
| (ml/100 g) | | | | | | | | | | |
| Tint strength | 107.4 | 110.1 | 112.0 | 113.5 | 115.2 | 116.7 | 150.0 | 119.7 | 123.8 | 127.5 |
| unit | | | | | | | | | | |

TABLE 8
Colloidal Properties of Carbon Black Composition (N234, N134 and N660 based)

| Colloidal Property | P32 | P33 | P35 | P37 | P58 | P36 | P38 | P40 |
|---|---|---|---|---|---|---|---|---|
| Iodine | 121.50 | 159.20 | 146.75 | 171.75 | 181.50 | 204.20 | 37.50 | 78.30 |
| adsorption | | | | | | | | |
| number(mg/g) | | | | | | | | |
| Nitrogen | 115.80 | 153.80 | 139.90 | 165.80 | 176.90 | 197.40 | 35.10 | 75.6 |
| surface area | | | | | | | | |
| (NSA) m2/g | | | | | | | | |
| Statistical | 107.90 | 134.10 | 134.60 | 154.00 | 153.40 | 167.80 | 35.10 | 69.00 |
| surface area | | | | | | | | |
| (STSA) m2/g | | | | | | | | |
| Oil absorption | 121.9 | 113.5 | 121.4 | 114.2 | 114.6 | 106.6 | 91.2 | 89.7 |
| number OAN | | | | | | | | |
| (ml/100 g) | | | | | | | | |
| Compressed | 95.3 | 91.8 | 101.3 | 99.6 | 96.1 | 94.1 | 72.4 | 71.2 |
| Oil absorption | | | | | | | | |
| number | | | | | | | | |
| (ml/100 g) | | | | | | | | |
| Tint strength | 119.0 | 124.1 | 128.1 | 129.8 | 132.3 | 134.7 | 60.3 | 75.2 |
| unit | | | | | | | | |

TABLE 9
Colloidal Properties of Carbon Black Composition (N774 and N550 based)

| Colloidal Property | P41 | P42 | P43 | P44 | P51 | P52 | P53 | P54 | P61 |
|---|---|---|---|---|---|---|---|---|---|
| Iodine | 30.50 | 78.75 | 99.10 | 151.25 | 43.20 | 86.10 | 106.90 | 151.20 | 105.10 |
| adsorption | | | | | | | | | |
| number(mg/g) | | | | | | | | | |
| Nitrogen | 31.50 | 72.12 | 97.46 | 142.32 | 36.09 | 79.34 | 101.07 | 142.84 | 94.80 |
| surface area | | | | | | | | | |
| (NSA) m2/g | | | | | | | | | |
| Statistical | 31.50 | 68.1 | 83.59 | 117.91 | 36.09 | 71.4 | 86.7 | 118.02 | 87.3 |
| surface area | | | | | | | | | |
| (STSA) m2/g | | | | | | | | | |
| Oil absorption | 73.0 | 76.5 | 80.1 | 82.7 | 119.6 | 116.2 | 113.5 | 110 | 116.8 |
| number OAN | | | | | | | | | |
| (ml/100 g) | | | | | | | | | |
| Compressed | 62.2 | 66.1 | 68.3 | 82.2 | 82.7 | 79.3 | 80.2 | 80.7 | 88.1 |
| Oil absorption | | | | | | | | | |
| number OAN | | | | | | | | | |
| (ml/100 g) | | | | | | | | | |
| Tint strength | 53.8 | 69.2 | 80.1 | 95.2 | 57.8 | 72.1 | 81.5 | 98.3 | 93.8 |
| unit | | | | | | | | | |

Colour Property of Carbon Black Composition

The colour property of carbon black or carbon black composition is measured by ASTM D3265 in tint strength unit and it is the indication of hiding power of whiteness value of a white pigment by carbon black. Higher tint strength value of carbon black indicates higher intensity of black colour of carbon black.

The tint strength of carbon black composition comprising one first carbon black, filler 1, having iodine adsorption number in the range of about 25 mg/g to 160 mg/g, nitrogen surface area (NSA) in the range of 20 m²/g to 150 m²/g, oil absorption number (OAN) in the range of 70 ml/100 g to 140 ml/100 g, and one second carbon black, filler 2, having iodine adsorption number in the range of 160 mg/g to 300 mg/g, nitrogen surface area (NSA) in the range of 160 m²/g to 300 m²/g, oil absorption number (OAN) in the range of 50 ml/100 g to 120 ml/100 g show higher value, wherein, the carbon black compositions contain different amount of increasing filler 2.

For carbon black composition comprising one first carbon black, having iodine adsorption number in the range of 60 mg/g to 100 mg/g, nitrogen surface area (NSA) in the range of 70 m²/g to 100 m²/g, oil absorption number (OAN) in the range of 60 ml/100 g to 130 ml/100 g as filler 1 and one second carbon black, having iodine adsorption number in the range of 200 mg/g to 270 mg/g and oil absorption number (OAN) in the range of 50 ml/100 g to 110 ml/100 g, filler 2, the tint strength improved by about 20% for carbon black composition, P31 consisting of 50 wt. % of filler 1, and 50 wt. % of filler 2, when compared with P22 contains 100 wt. % of filler 1, Table 7 and FIG. 1.

For carbon black composition comprising one first carbon black, filler 1, having iodine adsorption number in the range between 115 mg/g to 160 mg/g, nitrogen surface area (NSA) in the range between 110 m²/g and 150 m²/g and oil absorption number (OAN) in the range of 110 ml/100 g to 140 ml/100 g and one second carbon black, having filler 2, iodine adsorption number in the range of 200 mg/g to 270 mg/g and oil absorption number (OAN) in the range of 50 ml/100 g to 110 ml/100 g, the tint strength improved by about 5.5 and 4.2% for carbon black composition P36 and P33 contains 50 wt. % of filler 1, and 50 wt. % of filler 2, when compared with P35 and P32 contains 100 wt. % of filler 1, Table 8 and FIG. 1.

For carbon black composition comprising one first carbon black, having iodine adsorption number in the range of 25 mg/g to 50 mg/g, nitrogen surface area (NSA) 25 m²/g to 45 m²/g, oil absorption number (OAN) 60 ml/100 g to 130 ml/100 g filler 1, and one second carbon black, as filler 2, having iodine adsorption number in the range of 200 mg/g to 270 mg/g and oil absorption number (OAN) in the range of 50 ml/100 g to 110 ml/100 g, the tint strength improved by about 65, 80.7, 82.7, and 129.2% for carbon black composition P39, P44, P63 and P61 respectively contains 50 wt. % of filler 1, and 50 wt. % of filler 2, when compared with P38 contains 100 wt. % of filler 1 (N660), P41 contains 100 wt. % of filler 1 (N774), P51 contains 100 wt. % of filler 1 (N550), Table 8 and Table 9 and FIG. 1.

Aggregate Size Distribution (ASD) of Carbon Black Composition

The present invention belongs to carbon black composition comprising at least one first carbon black, filler 1, with iodine adsorption number in the range of about 25 to 160 mg/g, preferably in the range of about 40 to 150 mg/g; nitrogen surface area (NSA) in the range of 20 to 150 m²/g, preferably in the range of 35 to 140 m²/g; oil absorption number (OAN) in the range of 70 to 140 ml/100 g, more preferably, in the range of 80 to 125 ml/100 g with at least one second carbon black, filler 2, preferably, with iodine adsorption number in the range of 160 to 300 mg/g, nitrogen surface area (NSA) in the range of 160 m²/g to 300 m²/g, oil absorption number (OAN) in the range of 50 to 120 ml/100 g, wherein, the weight of the second carbon black, filler 2, in the carbon black composition is varying between 0.5 wt. % and 99.5 wt. %.

The present invention shows carbon black composition grade comprising at least two different carbon blacks, one first carbon black, and filler1, and one second carbon black, filler 2 of unimodal aggregate size distribution (ASD) i.e. only one peak in the entire aggregate size distribution for the carbon black composition. The carbon black composition grade of the present invention shows unimodal aggregate size distribution when iodine adsorption number of filler 1 ranges about 55 mg/g to 145 mg/g, preferably ranges about 65 mg/g to 135 mg/g; nitrogen surface area (NSA) in the range of about 60 m²/g to 140 m²/g, preferably in the range of 70 m²/g to 130 m²/g; oil adsorption number (OAN) ranges about 70 ml/100 g to 140 ml/100 g, preferably in the range of 80 ml/100 g to 130 ml/100 g, FIG. 2 and FIG. 3.

The present invention shows carbon black composition comprising at least two different carbon blacks, one first carbon black, filler 1, and one second carbon black, filler 2, of bimodal aggregate size distribution (ASD) i.e. two peaks in the entire aggregate size distribution for the carbon black composition.

The carbon black composition of the present invention shows, bimodal aggregate size distribution i.e. at least two peaks in the entire aggregate size distribution, when iodine adsorption number of filler 1 ranges about 25 to 55 mg/g; nitrogen surface area (NSA) in the range of about 25 to 50 m²/g; oil absorption number (OAN) ranges about 60 to 130 ml/100 g, FIG. 4.

The ratio of mass weighted average aggregate size, D_{W}, and number weighted average aggregate size, D_{N}, indicates homogeneity of aggregate size distribution. Higher value of the ratio represents inhomogeneity, relatively lower value of the ratio, more towards unity, represents more homogeneity in blending aggregate size distribution. In the present carbon black composition, with progressive increase in the content of EXP1, the ratio of D_{W}/D_{N} increases. For carbon black composition, P22 (N339:EXP1=100:00), the value of ratio is 1.40, wherein, for P24 (N339:EXP1=90:10), P25 (N339:EXP1=85:15), P26 (N339:EXP1=80:20), P29 (N339:EXP1=70:30), P30 (N339:EXP1=60:40), P31 (N339:EXP1=50:50), P28 (N339:EXP1=00:100) the value of the ratio is 1.67, 1.66, 1.72, 1.91, 1.94, 1.98, 1.6 respectively, Table 10.

For carbon black composition, P35 (N134:EXP1=100:00), the value of ratio is 1.40, wherein, for P37 (N134:EXP1=80:20), P36 (N134:EXP1=50:50), the value of the ratio is 1.42, 1.52 respectively, Table 10.

The ratio of D_{W}/D_{N} of carbon black composition containing N134 as filler 1, exhibits better homogeneity with filler 2, when compared with N339 under comparable weight ratio. Carbon black composition containing N339 (P22, P23, P24, P25, P26 and P29) and N134 (P35, P37 and P36) as filler 1, exhibit unimodal aggregate size distribution as observed from FIG. 2 and FIG. 3.

The ratio of D_{W}/D_{N} of carbon black composition containing N660 as filler 1, exhibits inhomogeneity with filler 2, when compared with N339 under comparable weight ratio. Carbon black composition containing N339 (P22, P23, P24, P25, P26 and P29) and N134 (P35, P37 and P36) as filler 1, exhibit unimodal aggregate size distribution as observed from FIG. 2 and FIG. 3, however, for carbon black composition P40 and P39 containing 20 wt. % (curve 3, FIG. 4) and 50 wt. % (curve 4, FIG. 4) of filler 2, in filler 1, N660, bimodal distribution of aggregate size observed.

The distribution of width of aggregate size is expressed by the full width at half maximum (FWHM) and indicated as ΔD50. The ΔD50 represents the breadth of the mass distribution measured at the half maximum point of mode in differential volume distribution curve of aggregate size distribution of carbon black. A relative fractional measure of breadth is derived by dividing ΔD50 by modal diameter, D_{Mode}, and expressed as ΔD50/D_{Mode}. This ratio measures the broadness of the aggregate size distribution curve without inferring the smaller and larger aggregate size.

For carbon black composition, P22 (N339:EXP1=100:00), P23 (N339:EXP1=95:05), P24 (N339:EXP1=90:10), P25 (N339:EXP1=85:15), P26 (N339:EXP1=80:20), P29 (N339:EXP1=70:30), P30 (N339:EXP1=60:40), P31 (N339:EXP1=50:50), the value of ΔD50, and ΔD50/D_{Mode} progressively increase from 63 nm and 0.625 (P22) to 88 nm and 0.93 with increase of wt. % of filler 2, EXP1 in filler 1, N339, Table 10, FIG. 5 and FIG. 6. The invention belongs to carbon black composition showing a wider aggregate size distribution characterized by ΔD50 and ΔD50/D_{Mode}.

For carbon black composition, P35 (N134:EXP1=100:00), P37 (N134:EXP1=80:20), P36 (N134:EXP1=50:50), the value of ΔD50, and ΔD50/D_{Mode} progressively increase from 55 nm and 0.695 (P35) to 58 nm and 0.88 with increase of wt. % of filler 2, EXP1 in filler 1, N134, Table 10, FIG. 7 and FIG. 8.

However, for carbon black composition, P38 (N660:EXP1=100:00), P40 (N660:EXP1=80:20), P39 (N660:EXP1=50:50), the value of ΔD50, and ΔD50/D_{Mode} do not change significantly, P38 (ΔD50−156 nm, ΔD50/D_{Mode} 0.831), P40 (ΔD50−157 nm, ΔD50/D_{Mode} 0.86) and P39 (ΔD50−153 nm, ΔD50/D_{Mode} 0.856) with increase of wt. % of filler 2, EXP1 in filler 1, N660, Table 10, FIG. 9 and FIG. 10.

TABLE 10
Aggregate Size Distribution (ASD) of Carbon Black Composition

| | Unit | P22 | P24 | P25 | P26 | P29 | P30 | P31 | P35 | P37 | P36 | P38 | P40 | P39 | P28 |
|---|---|---|---|---|---|---|---|---|---|---|---|---|---|---|---|
| Mean | nm | 113 | 112 | 105 | 102 | 101 | 96 | 92 | 78 | 72 | 67 | 225 | 208 | 182 | 59 |
| Mode | nm | 101 | 98 | 95 | 93 | 98 | 96 | 94 | 79 | 71 | 66 | 188 | 183 | 179 | 56 |
| ΔD50 | nm | 63 | 66 | 65 | 65 | 75 | 86 | 88 | 55 | 56 | 58 | 156 | 157 | 153 | 50 |
| ΔD50/Mode | — | 0.63 | 0.67 | 0.68 | 0.7 | 0.77 | 0.9 | 0.9 | 0.7 | 0.8 | 0.88 | 0.83 | 0.9 | 0.86 | 0.88 |
| (D90 − | — | 0.94 | 1.09 | 1.02 | 1.02 | 1.11 | 1.12 | 1.19 | 0.7 | 0.8 | 0.86 | 1.03 | 1.05 | 1.38 | 0.88 |
| D10)/D50 | | | | | | | | | | | | | | | |
| D_{W}/D_{N} | — | 1.4 | 1.67 | 1.66 | 1.7 | 1.91 | 1.9 | 2 | 1.4 | 1.4 | 1.52 | 1.57 | 3.1 | 4.02 | 1.6 |

Curing of Elastomer Compounds

The curing characteristics of elastomer compounds were evaluated in oscillating disk rheometer (ODR) at 145° C. for 30 minutes for NR/BR elastomer compounds, 160° C. for 30 minutes for SBR/BR elastomer compounds, 170° C. for 30 minutes for IIR elastomer compounds, 160° C. for 30 minutes for NBR elastomer compounds, 170° C. for 30 minutes for EPDM elastomer compounds.

Molding of Rubber Compounds

The molding and curing of the rubber compounds to prepare elastomer compounds as described in Table 2, Table 3, Table 4, Table 5 and Table 6 were performed in a compression press for a predetermined temperature of 175° C. or less, 160° C. or less, from about 145° C. to about 175° C. or any other predetermined temperature in between, under a pressure of about 250 kg/cm², more preferably under a pressure of about 200 kg/cm² for a predetermined time period of 60 minutes or less, 45 minutes or less, from about 10 minutes to about 40 minutes or any other predetermined time in between.

Properties of Elastomer Compounds

Comparison of Dispersibility

Carbon black is used as a filler within vulcanizable rubber compositions of matter that are used to make tyre components and other rubber articles. The degree of carbon black dispersion within these compositions ultimately impacts the properties of the tyre or other rubber articles.

Carbon black is typically added to these rubber compositions during compounding, which is a process that includes mixing of rubber, filler, and other compound components. During mixing, processing aids have been added to improve the degree of carbon black dispersion [continuation of U.S. Ser. No. 10/022,108, filed on Dec. 13, 2001],

Filler dispersibility is mainly influenced by interactions between agglomerates and/or aggregates, in other words, the force/energy needed in order to separate two objects. For carbon black, these interactions are mainly due to van der Waals forces, which are very low compared to the hydrogen bonding existing between silica objects. In addition, pelletization process has a great influence on dispersibility—any action leading to a higher compaction of the filler increases interaction between filler objects and so decreases its dispersibility. In addition to filler's surface energy, which is of major importance, dispersion can also be influenced by filler's morphological properties. Dispersion is highly influenced by filler surface area: the higher surface area of carbon black, the poorer the dispersion. This result is probably due to the fact that high surface area usually has smaller aggregates, which will develop more interactions with their neighbors in the dry state. Filler structure also has a neat influence on dispersion: the higher the structure, the better the dispersion. This result is well established and likened to the fact that more “open” aggregate structures develop a lower number of contacts with their neighbors in the dry state. [James E. Mark, Burak Erman, Frederick R. Eirich, Science and Technology of RUBBER (Academic Press is an imprint of Elsevier, Third Edition, 2005)].

The dispersibility properties of carbon black elastomer compounds were evaluated following standard ISO 11345 (Dispersion (%), X, average agglomerate size) dispersibility properties of the elastomer compounds with respect to comparative samples are shown in Table 11.

The disper GRADER alpha view is an advanced reflected light microscopy designed to measure filler dispersion in elastomer compound.

Dispersion (%) value indicates the % level of dispersibility of carbon black (or filler) in the elastomer compound.

The X value is the inbuilt equipment rating of carbon black agglomerate in elastomer compound relative to the image reference scan. This is measure for filler distribution and higher the value of X indicates better distribution.

The average agglomerate size (pm) in the disperGRADER is the average of all visible agglomerate diameter of the carbon black in the elastomer compounds.

TABLE 11
Dispersion (%), X and Average AgglomerateSize
Data of Elastomer Compounds

| | | | Disper- | | Average |
|---|---|---|---|---|---|
| | Rubber | Carbon black | sion | | agglomerate |
| UIN | System | Composition | (%) | X | size(um) |
| P26C | NR/BR | N339:B219 = 80:20 | 98.2 | 9.65 | 7.56 |
| P30C | | N339:B219 = 60:40 | 97.65 | 8.7 | 10.47 |
| P31C | | N339:B219 = 50:50 | 97.29 | 7.98 | 9.98 |
| P28C | | N339:B219 = 00:100 | 90.26 | 6.58 | 11.07 |
| P35C | NR/BR | N134:B219 = 100:00 | 97.5 | 9.5 | 8.9 |
| P37C | | N134:B219 = 80:20 | 95.8 | 8.8 | 8.9 |
| P36C | | N134:B219 = 50:50 | 89.01 | 7.7 | 10.4 |
| P57C | SBR/BR | N134:B219 = 80:20 | 99.47 | 9.36 | 8.67 |
| P59C | | N134:B219 = 50:50 | 97.33 | 7.3 | 10.53 |
| P60C | | N134:B219 = 00:100 | 87.71 | 6 | 11.84 |
| P47C | NBR | N660:B219 = 80:20 | 99.87 | 10 | 6.67 |
| P49C | | N660:B219 = 50:50 | 99.58 | 9.99 | 7.37 |
| P50C | | N660:B219 = 00:100 | 99.11 | 9.77 | 7.55 |
| P52C | EPDM | N550:B219 = 80:20 | 98.2 | 9.74 | 7.48 |
| P54C | | N550:B219 = 50:50 | 95.5 | 7.93 | 10.21 |
| P55C | | N550:B219 = 00:100 | 92.31 | 7.41 | 10.38 |
| P42C | HR | N774:B219 = 80:20 | 97.6 | 9.01 | 8.41 |
| P44C | | N774:B219 = 50:50 | 92.66 | 7.54 | 9.62 |
| P45C | | N774:B219 = 00:100 | 89.14 | 6.9 | 10.15 |

Dispersibility Properties of Elastomer Compounds

The Dispersion (%), represents the % level of dispersibility of carbon black (or filler) in the elastomer compound. Highest dispersion compounds having the value of dispersion (%)—100, lowest dispersion compounds having the value of dispersion (%)—0; X value represent the rating of filler distribution in elastomer compounds. X-10 indicate highest filler distribution, X-0 indicate lowest filler distribution; Average agglomerate size represent the average agglomerate diameter of all counted agglomerate of carbon black in elastomer compound. Lower average agglomerate size indicates better dispersion and vice-versa. Dispersibility of elastomer compounds containing different levels of one first carbon black, filler 1, and one second carbon black, filler 2, P26C (N339:EXP1—80:20), P30C (N339:EXP1—60:40), P31C (N339:EXP1—50:50) and P28C (EXP1 100, comparative example); P57C (N134:EXP1—80:20), P59C (N134:EXP1—50:50), P60C (N134:EXP1—00:100, comparative sample); P42C (N774:EXP1—80:20), P44C (N774:EXP1—50:50), P45C (N774:EXP1—00:100, comparative sample); P47C (N660:EXP1—80:20), P49C (N660:EXP1—50:50), P50C (660:EXP1—00:100, comparative sample); P54C (N550:EXP1—50:50), P55C (N550:EXP1—00:100 comparative sample) in the carbon black composition, show the progressive increasing in the value of dispersion (%), X and decreasing value of average agglomerate size indicating improved dispersion of carbon black in elastomer compound with increase in content of one second carbon black, filler 1, in the carbon black composition with respect to P28C, P60C, P45C, P50C and P55C respectively.

Mechanical Properties of Elastomer Compounds

The present invention relates to elastomer compounds of natural rubber, synthetic rubbers or their predefined blends comprising carbon black composition having synergistically enhanced distribution of width of aggregate size ΔD50 to provide improved mechanical properties such as, tear strength, and cut growth etc. of the elastomer compounds, wherein, the Elastomeric compound having synergistically enhanced dispersion of carbon black composition is made by mixing at least two different carbon blacks, at least one first carbon black, filler 1, with iodine adsorption number in the range of about 25 to 160 mg/g, preferably in the range of about 40 to 150 mg/g; nitrogen surface area (NSA) in the range of 20 to 150 m²/g, preferably in the range of 35 to 140 m²/g; oil absorption number (OAN) in the range of 70 to 140 ml/100 g, more preferably, in the range of 80 to 125 ml/100 g with at least one second carbon black, filler 2, preferably with iodine adsorption number in the range of 160 to 300 mg/g, nitrogen surface area (NSA) in the range of 160 to 300 m²/g, oil absorption number (OAN) in the range of 50 to 120 ml/100 g, in the carbon black composition is varying between 0.5 wt. % and 99.5 wt. %, preferably varying between 2.5 wt. % and 97.5 wt. % and the content of carbon black composition in the elastomer compound is in the range of about 0.05 phr to 200 phr.

The mechanical properties of elastomer compounds were evaluated following standard ASTMD412 (tensile strength, elongation at break, modulus), ASTM D624 (tear strength), ASTM D430 (cut growth).Changes in mechanical properties of the elastomer compounds) are shown in Table 12, Table 13, Table 14, Table 15, and Table 16 and FIG. 11, FIG. 12, FIG. 13 and FIG. 14.

The mechanical properties value of comparative samples (P22C, P35C, P38C, P56C, P41C, P46C, P51C—data not shown) are converted to 100 in each elastomer compound and the mechanical properties value of the experimental elastomer compounds are relatively compared with respect to comparative samples as 100, Table 12, Table 13, Table 14, Table 15, and Table 16. Since the mechanical properties value of experimental samples are relatively compared with comparative samples considering the mechanical properties value as 100. The value in bracket is absolute value. The value in bracket is absolute value with unit MPa, MPa, %, N/mm, mm for tensile strength, modulus at 300%, elongation at break, tear strength, cut growth respectively.

TABLE 12
Changes in Mechanical Properties of
Elastomer Compounds (N339/EXP-1)

| | P23C | P24C | P25C | P26C | P27C | P29C | P30C | P31C |
|---|---|---|---|---|---|---|---|---|
| Tensile | 100 | 99.15 | 100.4 | 100.1 | 100.5 | 101.4 | 103.4 | 104.1 |
| Strength | | | | | | | | |
| Modulus | 90.1 | 90.5 | 87.9 | 86.2 | 80.2 | 83.9 | 85.5 | 71.6 |
| at 300 | | | | | | | | |
| Elongation | 103.4 | 98.9 | 101.6 | 103.2 | 107.3 | 106.3 | 108.1 | 117.1 |
| atBreak | | | | | | | | |
| Tear | 100 (104) | 96.2 (100) | 103.8 (108) | 101.9 (106) | 104.8 (109) | 135.6 (137) | 141.6 (143) | 148.5 (150) |
| Strength | | | | | | | | |
| Cut | | | | | | | | |
| Growth | | | | | | | | |
| 10 KC | 114.3 (12.81) | 118.8 (13.32) | 126.0 (14.12) | 101.8 (11.41) | 103.0 (11.55) | 93.5 (10.48) | 100.4 (11.26) | 93.3 (10.46) |
| 20 KC | 105.8 (19.61) | 113.5 (21.04) | 114.7 (21.26) | 100.1 (18.55) | 100.2 (18.57) | 87.0 (16.13) | 92.4 (17.13) | 87.6 (16.24) |

Changes in Mechanical Properties of Elastomer Compounds
(NR/BR)(N134/B219] and N660/B219)

| | P36C | | P37C | | P39C | | P40C | |
|---|---|---|---|---|---|---|---|---|
| Tensile | 108 | (25.04) | 103 | (23.72) | 115 | (20.91) | 101 | (18.48) |
| Strength | | | | | | | | |
| Modulus | 79 | (6.18) | 92 | (7.2) | 83 | (6.06) | 100 | (7.34) |
| at 300% | | | | | | | | |
| Elongation | 115 | (671) | 105 | (614) | 116 | (630) | 101 | (548) |
| at Break | | | | | | | | |
| Tear | 121 | (198) | 105 | (173) | 132 | (102) | 117 | (90) |
| Strength | | | | | | | | |
| Cut | | | | | | | | |
| Growth | | | | | | | | |
| 10 KC | 91.1 | (18.35) | 101.9 | (20.53) | 80.6 | (9.54) | 82.2 | (9.73) |

| | | | | | | |
|---|---|---|---|---|---|---|
| 20 KC | X | X | 86.3 | (14.32) | 95.2 | (15.81) |

TABLE 13
Changes in Mechanical Properties of Elastomer Compounds
(Butyl Rubber) (N774/B219) and (N774/B361)

| | P42C | | P43C | | P44C | | P45C | | P63C | | P64C | |
|---|---|---|---|---|---|---|---|---|---|---|---|---|
| Tensile | 111.1 | (10.04) | 113.1 | (10.22) | 114.9 | (10.39) | 134.8 | (12.19) | 117.8 | (10.65) | 146.6 | (13.25) |
| Strength | | | | | | | | | | | | |
| Modulus | 99.0 | (4.77) | 96.7 | (4.66) | 87.3 | (4.21) | 66.8 | (3.22) | 84.0 | (4.05) | 63.1 | (3.04) |
| at 300% | | | | | | | | | | | | |
| Elongation | 105.9 | (519) | 107.3 | (526) | 108.6 | (532) | 127.6 | (625) | 115.9 | (568) | 135.7 | (665) |
| at Break | | | | | | | | | | | | |
| Tear | 118.2 | (39) | 127.3 | (42) | 148.5 | (49) | 278.8 | (92) | 166.7 | (55) | 297.0 | (98) |
| Strength | | | | | | | | | | | | |
| Cut | | | | | | | | | | | | |
| Growth | | | | | | | | | | | | |
| 10 KC | 91.6 | (24.17) | 87.6 | (23.10) | 73.4 | (19.35) | 46.6 | (12.30) | 70.7 | (18.65) | 44.7 | (11.8) |

All samples failed before 20 KC in table 13.

TABLE 14
Changes in Mechanical Properties of Elastomer
Compounds (SBR/BR) (N134/ B219)

| | P57C | | P58C | | P59C | | P60C | |
|---|---|---|---|---|---|---|---|---|
| Tensile Strength | 100.9 | (22.0) | 103.1 | (22.48) | 105.4 | (22.98) | 109.9 | (23.96) |
| Modulus at 300% | 89.5 | (6.39) | 84.9 | (6.06) | 82.6 | (5.9) | 68.2 | (4.87) |
| Elongation at Break | 104.2 | (692) | 105.1 | (698) | 107.4 | (713) | 120.5 | (800) |
| Tear Strength | 106.7 | (95) | 109.0 | (97) | 114.6 | (102) | 122.5 | (109) |
| Cut Growth | | | | | | | | |
| 10 KC | 99.6 | (9.46) | 92.4 | (8.78) | 94.8 | (9.01) | 88.7 | (8.67) |
| 20 KC | 97.1 | (13.3) | 91.2 | (12.5) | 91.3 | (12.15) | 90.4 | (12.38) |

TABLE 15
Changes in Mechanical Properties of Elastomer Compounds (NBR) (N660/B219)

| | P47C | | P48C | | P49C | | P50C | |
|---|---|---|---|---|---|---|---|---|
| Tensile Strength | 100.3 | (19.38) | 108.7 | (21.0) | 114.4 | (22.1) | 124.7 | (24.1) |
| Modulus at 300% | 91.6 | (10.88) | 86.0 | (10.22) | 84.2 | (10.0) | 61.4 | (7.3) |
| Elongation at Break | 106.8 | (458) | 115.4 | (495) | 124.0 | (532) | 138.9 | (596) |
| Tear Strength | 111.9 | (66) | 118.6 | (70) | 127.1 | (75) | 145.8 | (86) |
| Cut Growth | | | | | | | | |
| 10 KC | 103.1 | (13.91) | 91.6 | (12.36) | 88.3 | (11.91) | 95.3 | (12.86) |
| 20 KC | 107.2 | (20.55) | 97.5 | (18.7) | 89.8 | (17.21) | 108.9 | (20.88) |

TABLE 16
Changes in Mechanical Properties of Elastomer Compounds (EPDM) (N550/B219 or N115)

| | P52C | | P53C | | P54C | | P55C | | P61C | | P62C | |
|---|---|---|---|---|---|---|---|---|---|---|---|---|
| Tensile | 85.8 | (5.82) | 82.2 | (5.57) | 93.2 | (6.32) | 118.3 | (8.02) | 106.2 | (7.2) | 110.6 | (7.5) |
| Strength | | | | | | | | | | | | |
| Elongation | 80.2 | (215) | 77.6 | (208) | 90.3 | (242) | 142.5 | (382) | 94.8 | (254) | 111.6 | (299) |
| at Break | | | | | | | | | | | | |
| Tear | 107.7 | (42) | 107.7 | (42) | 115.4 | (45) | 135.9 | (53) | 112.8 | (44) | 130.8 | (51) |
| Strength | | | | | | | | | | | | |

The mechanical properties of elastomer compounds, such as, tensile strength, modulus, elongation at break, tear strength, cut growth, are shown in Table 12, Table 13, Table 14, Table 15 and Table 16. The raw data (within parenthesis) for mechanical and colour property has been customized (the other data in the cell) for plotting the FIG. 11, 12, 13 and FIG. 14.

Tear Strength

Elastomer compounds, P23C, P24C, P25C, P26C, P27C, P29C, P30C, P31C, Table 12, comprising carbon black composition, N339 as filler 1, and EXP1 as filler 2, show higher tear strength when incorporated into NR/BR, when the carbon black composition comprising increased amount of filler 2, Table 12.

For elastomer compound P31C, comprising carbon black composition of 50 wt. % one first carbon black, filler 1, N339 and 50 wt. % one second carbon black, filler 2, EXP 1, Table 12, show higher tear strength, when the carbon black composition containing larger amount of filler 2 in the carbon black composition, Table 12 (continuation).

Elastomer compounds, P37C, P36C, Table 12 (continuation), comprising carbon black composition, N134 as filler 1, and EXP1 as filler 2, show higher tear strength, when the carbon black composition containing larger amount of filler 2 in the carbon black composition, Table 12 (continuation).

Elastomer compounds, P40C, P39C, Table 12 (continuation), comprising carbon black composition, N660 as filler 1, and EXP 1 as filler 2, show higher tear strength, when the carbon black composition containing larger amount of filler 2, Table 12.

Elastomer compounds, P42C, P43C, P44C and P45C, P63C Table 13, comprising carbon black composition, N774 as filler 1, and EXP 1 and EXP 3 as filler 2, show higher tear strength, when the carbon black composition containing larger amount of filler 2 in the carbon black composition, Table 13.

Elastomer compounds, P57C, P58C, P59C and P60C, Table 14, comprising carbon black composition, N134 as filler 1, and EXP1 as filler 2, show higher tear strength when incorporated into SBR/BR, with increasing amount of filler 2 in the carbon black composition, Table 14.

Elastomer compounds, P47C, P48C, P49C and P50C, Table 15, comprising carbon black composition, N660 as filler 1, and EXP 2 as filler 2, show higher tear strength, when the carbon black composition containing larger amount of filler 2 in the carbon black composition, Table 15.

Elastomer compounds, P52C, P53C, P54C and P55C, P61C, Table 16, comprising carbon black composition, N550 as filler 1, and EXP 1 and EXP 2 as filler 2, show higher tear strength, when the carbon black composition containing larger amount of filler 2 in the carbon black composition, Table 16.

[The raw data (within parenthesis) for tear strength have been customized (the other data in the cell) for plotting the FIG. 11.]

Cut Growth

The cut growth of elastomer compounds, Table 12 to Table 15, comprising carbon black composition, N339, N134, N660 and N774 as filler 1, and EXP1, EXP3 as filler 2, show at least improvement in cut growth under 10KC and 20KC, when the carbon black composition containing till about 30 wt. % of filler 2, more preferably 50 wt. % of filler 2 in the carbon black composition, preferably about 50 wt. % of filler 2 in carbon black composition, Table 12 to Table 15. [The raw data (within parenthesis) for cut growth improvement property have been customized (the other data in the cell) in tables]

Elongation at Break

The elastomer compounds, Table 12 to Table 16, comprising carbon black composition, N339, N134, N660 and N774 as filler 1, and EXP1, EXP 2, EXP3 as filler 2, show improvement in elongation at break, when the carbon black composition containing till about 50 wt. % of filler 2 in the carbon black composition of filler 1 Table 12 to Table 16. [The raw data (within parenthesis) for cut elongation at break have been customized (the other data in the cell) in tables]

Tensile Strength

The elastomer compounds, Table 12 to Table 16, comprising carbon black composition, N339, N134, N660 and N774 as filler 1, and EXP1, EXP 2, EXP3 as filler 2, show improvement tensile strength when the carbon black composition containing larger amount of filler 2 in the carbon black composition 50 wt. % of filler 2 in the carbon black composition of filler 1 shown in Table 12 to Table 16.

Colour Properties of Elastomer Compounds

The present invention relates to elastomer compounds of natural rubber, synthetic rubbers or their predefined blends comprising carbon black composition to provide improved colour properties such as, L* of the elastomer compounds, wherein, the carbon black composition is made by mixing at least two different carbon blacks, at least one first carbon black, filler 1, with iodine adsorption number in the range of about 25 to 160 mg/g, preferably in the range of about 40 to 150 mg/g; nitrogen surface area (NSA) in the range of 20 to 150 m2/g, preferably in the range of 35 to 140 m2/g; oil absorption number (OAN) in the range of 70 to 140 ml/100 g, more preferably, in the range of 80 to 125 ml/100 g with at least one second carbon black, filler 2, preferably with iodine adsorption number in the range of 160 to 300 mg/g, nitrogen surface area (NSA) in the range of 160 to 300 m2/g, oil absorption number (OAN) in the range of 50 to 120 ml/100 g, when compared with elastomer compounds comprising the first carbon black, of iodine adsorption number in the range of about 25 to 160 mg/g, preferably in the range of about 40 to 150 mg/g; nitrogen surface area (NSA) in the range of 20 to 150 m2/g, preferably in the range of 35 to 140 m2/g; oil absorption number (OAN) in the range of 70 to 140 ml/100 g, more preferably, in the range of 80 to 125 ml/100 g, wherein, the weight of the second carbon black, filler 2, in the carbon black composition is varying between 0.5 wt. % and 99.5 wt. %, preferably varying between 2.5 wt. % and 95 wt. % and the content of carbon black composition in the elastomer compound is in the range of about 0.05 phr to 200 phr.

The L* value of comparative samples, P22C, P35C, P38C, P56C, P41C, P46C, P51C are converted to 100 and the L* value of the experimental elastomer compounds is relatively compared with respect to comparative samples as 100, Table 17. The value in bracket is absolute L* value.

TABLE 17
Changes in L* value of Elastomer Compounds

| | | | Colour | |
|---|---|---|---|---|
| Rubber | Carbon black | | Properties | |
| System | Composition | UIN | L* value | |
| NR/BR | N339:B219 = 100:00 | P22C | 100 | (15.2) |
| | N339:B219 = 95:05 | P23C | 100.9 | (15.38) |
| | N339:B219 = 90:10 | P24C | 94.5 | (14.41) |
| | N339:B219 = 85:15 | P25C | 92.5 | (14.11) |
| | N339:B219 = 80:20 | P26C | 80.9 | (12.34) |
| | N339:B219 = 75:25 | P27C | 66.9 | (10.2) |
| | N339:B219 = 70:30 | P29C | 47.1 | (7.19) |
| | N339:B219 = 60:40 | P30C | 42.4 | (6.46) |
| | N339:B219 = 50:50 | P31C | 38.7 | (5.9) |
| | N339:B219 = 00:100 | P28C | 33.1 | (5.05) |
| NR/BR | N660:B219 = 100:00 | P38C | 100 | |
| | N660:B219 = 50:50 | P39C | 74.5 | |
| SBR/BR | N134:B219 = 100:00 | P56C | 100 | (12.14) |
| | N134:B219 = 50:50 | P59C | 84.1 | (10.21) |
| EPDM | N550:B219 = 100:00 | P51C | 100 | (10.04) |
| | N550:B219 = 50:50 | P54C | 61.4 | (6.16) |
| | N550:N115 = 50:50 | P61C | 80.9 | (8.12) |
| HR | N774:B219 = 100:00 | P41C | 100 | (9.22) |
| | N774:B219 = 50:50 | P44C | 78.3 | (7.22) |
| | N774:B361 = 50:50 | P63C | 74.8 | (6.9) |

L* Value of Elastomer Compounds

The, L* value, of elastomer compounds containing different levels of one first carbon black, filler 1, and one second carbon black, filler 2, P23C (N339:EXP1—95:05), P24C (N339:EXP1—90:10), P25C (N339:EXP1—85:15), P26C (N339:EXP1—80:20), P27C (N339:EXP1—75:25), P29C (N339:EXP1—70:30), P30C (N339:EXP1—60:40), P31C (N339:EXP1—50:50) and P28C (EXP1 100); P39C(N660:B219], P59C (N134:EXP1—50:50); P44C (N774:EXP1—50:50), P63C (N774:EXP3—50:50); P51C (N550:EXP1—100:00, comparative example), P54C (N550:EXP1—50:50), P61C (N550:EXP2—50:50) in the carbon black composition, show the progressive decrease in the value of L* indicating improved colour density of the elastomer compound with increase in content of one second carbon black, filler 2, in the carbon black composition

Thus by way of the present invention it is demonstrated that selective mixing of two carbon blacks providing synergistically enhanced distribution of width of aggregate size ΔD50, wherein one first carbon black, filler 1, having iodine adsorption number in the range of about 25 mg/g to 160 mg/g, nitrogen surface area (NSA) in the range of 20 m2/g to 150 m2/g, oil absorption number (OAN) in the range of 70 ml/100 g to 140 ml/100 g, and a second carbon black, filler 2, having iodine adsorption number in the range of 160 mg/g to 300 mg/g, oil absorption number (OAN) in the range of 50 ml/100 g to 120 ml/100 g, wherein, the second carbon black, filler 2 with composition between 0.5 wt. % and 99.5 wt. % when incorporated in elastomer compounds 0.05 phr to 200 phr exhibit surprisingly improved L* value with concomitant improvement of the mechanical properties such as tear strength, cut growth, tensile strength, elongation at break.

1. A carbon black composition suitable for elastomer compounds comprising, a select combination of (a) at least one first carbon black, having iodine adsorption number in the range of about 25 to 160 mg/g, nitrogen surface area (NSA) in the range of 20 to 150 m2/g, oil absorption number (OAN) in the range of 70 to 140 ml/100 g; and (b) at least one second carbon black, having iodine adsorption number in the range of 160 to 300 mg/g, nitrogen surface area (NSA) in the range of 160 to 300 m2/g, oil absorption number (OAN) in the range of 50 to 120 ml/100 g, and wherein said second carbon black, in the carbon black composition vary between 0.5 wt. % and 99.5 wt. % having synergistically enhanced distribution of width of aggregate size ΔD50.

2. The carbon black composition as claimed in claim 1 having synergistically enhanced distribution of width of aggregate size ΔD50 in the range of 50 nm to 160 nm and ratio of mass weighted average aggregate size, D_{W}, and number weighted average aggregate size, D_{N}, in the range of 1.4 to 4.02.

3. The carbon black composition as claimed in anyone of claim 1 or 2 having measure of broadness of the aggregate size distribution curve without inferring the smaller and larger aggregate size defined by ΔD50/D_{Mode} in the range of 0.63 to 0.9.

4. The carbon black composition as claimed in anyone of claims 1 to 3, wherein selective combination of said first carbon black and said second carbon black enable selectively variable unimodal aggregate size distribution or bimodal aggregate size distribution.

5. The carbon black composition as claimed in anyone of claims 1 to 4 comprising selective combinations including:
N339:EXP1=90:05, N339:EXP1=90:10, N339:EXP1=85:15, N339:EXP1=80:20, N339:EXP1=75:25, N339:EXP1=70:30, N339:EXP1=60:40, N339:EXP1=50:50, N234:EXP1=75:25, N134:EXP1=50:50, N134:EXP1=80:20, N134:EXP1=70:30, N660:EXP1=50:50, N660:EXP1=80:20, N660:EXP1=70:30, N774:EXP1=80:20, N774:EXP1=70:30, N774:EXP1=50:50, N774:EXP3=50:50, N550:EXP1=80:20, N550:EXP1=70:30, N550:EXP1=50:50 and N550:EXP2=50:50.

6. The carbon black composition as claimed in anyone of claims 1 to 5 comprising: carbon black composition, P23 (N339:EXP1=95:05), P24 (N339:EXP1=90:10), P25 (N339:EXP1=85:15), P26 (N339:EXP1=80:20), P29 (N339:EXP1=70:30), P30 (N339:EXP1=60:40), P31 (N339:EXP1=50:50), the value of ΔD50, and ΔD50/D_{Mode} synergistically increase from 63 nm and 0.625 (P22) to 88 nm and 0.93 with increase of wt. % of filler 2, EXP1, in filler 1, N339.

7. The carbon black composition as claimed in anyone of claims 1 to 5 comprising: carbon black composition P37 (N134:EXP1=80:20), P36 (N134:EXP1=50:50), the value of ΔD50, and ΔD50/D_{Mode} synergistically increase from 55 nm and 0.695 (P35) to 58 nm and 0.88 with increase of wt. % of filler 2, EXP1 in filler 1, N134.

8. The carbon black composition as claimed in anyone of claims 1 to 5 comprising: carbon black composition P40 (N660:EXP1=80:20), P39 (N660:EXP1=50:50), the value of ΔD50 changes synergistically, however, ΔD50/D_{Mode} do not change significantly, P38 (ΔD50−156 nm, ΔD50/D_{Mode} 0.831), P40 (ΔD50−157 nm, ΔD50/D_{Mode} 0.86) and P39 (ΔD50−153 nm, ΔD50/D_{Mode} 0.856) with increase of wt. % of filler 2, EXP1 in filler 1, N660.

9. An elastomer formulation incorporating carbon black composition as claimed in claims 1-8 including;
said carbon black composition having select combination of (A) at least one first carbon black, having iodine adsorption number in the range of about 25 to 160 mg/g, nitrogen surface area (NSA) in the range of 20 to 150 m2/g, oil absorption number (OAN) in the range of 70 to 140 ml/100 g; and (b) at least one second carbon black, having iodine adsorption number in the range of 160 to 300 mg/g, nitrogen surface area (NSA) in the range of 160 to 300 m2/g oil absorption number (OAN) in the range of 50 to 120 ml/100 g, and wherein said second carbon black, in the carbon black composition vary between 0.5 wt. % and 99.5 wt. % having synergistically enhanced distribution of width of aggregate size ΔD50 and (B) selectively co-acting rubber compounds having enhanced dispersibility of carbon black in the elastomer compound in the range of 87.71 to 99.87%, wherein said selectively co-acting rubber compounds include at least one homo- or co-polymers of natural rubber, epoxidized natural rubber, styrene butadiene rubber (SBR), polybutadiene rubber (PBR), butyl rubber (IIR), chlorobutyl rubber (CIIR), bromobutyl rubber, neoprene rubber (CR), nitrile rubber (NBR), ethylene propylene rubber (EPR), ethylene propylene diene rubber (EPDM), ethylene vinyl acetate (EVA) rubber, polyacrylic rubber, polysulfide rubber, silicone rubbers, fluoro elastomers or thermoplastic elastomer preferably NR/BR, SBR/BR, NBR, EPDM and IIR.

10. The elastomeric formulation as claimed in anyone of claims 9 to 10, wherein the said proportion of carbon black composition: selectively co-acting rubber compounds is in the range of 0.05 phr to 150 phr enhanced aesthetic and colour properties including L* value in the range of about 25.0 to about 3.0, favour selectively enhanced aesthetic and colour properties including L* value in the range of 15.38 to 5.05; tear strength in the range of about 15 N/mm to about 250 N/mm, more preferably in the range of 33 N/mm to 198 N/mm, about 240% to 750% elongation at break.

11. The elastomeric formulation as claimed in anyone of claim 9 or 10 comprising
filler 1, N339 having iodine adsorption number, 89.00 mg/g; nitrogen surface area (NSA), 86.20 m2/g; oil absorption number (OAN), 119.8 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition at total 45 phr carbon black N339 loading achieve a tear strength in the range of 145 N/mm to 155 N/mm.

12. The elastomeric formulation as claimed in anyone of claims 9 to 11 wherein, filler 1 (N660), iodine adsorption number, 37.5 mg/g; NSA) 35.1 m2/g; oil absorption number (OAN), 91.2 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition at total 45 phr carbon black N660 loading achieve a tear strength in the range of 95 N/mm to 110 N/mm.

13. The elastomeric formulation as claimed in anyone of claims 9 to 12, wherein, filler 1 (N134), having iodine adsorption number, 146.75 mg/g; NSA, 139.9 m2/g; oil absorption number (OAN), 121.4 ml/100 g; and filler 2, EXP1 B219 having iodine adsorption number, 256.75 mg/g; NSA 262.98 m2/g; oil absorption number (OAN), 94.8 ml/100 g with 50 wt. % of the total carbon black composition at total 45 phr carbon black N134 loading achieve a tear strength in the range of 195 N/mm to 210 N/mm.

14. The elastomeric formulation as claimed in anyone of claims 9 to 13, wherein, filler 1 (N774), iodine adsorption number, 30.5 mg/g; NSA, 31.5 m2/g; oil absorption number (OAN), 73.0 ml/100 g (OAN) and
filler 2, EXP1 B219 having iodine adsorption number, 256.75 mg/g; NSA 262.98 m2/g; oil absorption number (OAN), 94.8 ml/100 g with 50 wt. % of the total carbon black composition;
or
filler 2 (B361) Iodine adsorption number 292.0 mg/g; NSA 294.0 m2/g; oil absorption number 70 ml/100 gat 50 wt. % of total carbon black composition exhibit about 45 N/mm to 55 N/mm tear strength.

15. The elastomeric formulation as claimed in anyone of claims 9 to 14 wherein, filler 1 (N134), having iodine adsorption number, 146.75 mg/g; NSA, 139.9 m2/g; oil absorption number (OAN), 121.4 ml/100 g and
filler 2, EXP1 B219 having iodine adsorption number, 256.75 mg/g; NSA 262.98 m2/g; oil absorption number (OAN), 94.8 ml/100 g with 50 wt. % of the total carbon black composition
exhibit about 100 N/mm to 115 N/mm tear strength.

16. The elastomeric formulation as claimed in anyone of claims 9 to 15, wherein filler 1 (N660), iodine adsorption number, 37.5 mg/g; NSA) 35.1 m2/g; oil absorption number (OAN), 91.2 ml/100 g; and
filler 2, EXP1 B219 having iodine adsorption number, 256.75 mg/g; NSA 262.98 m2/g; oil absorption number (OAN), 94 ml/100 g with 50 wt. % of the total carbon black composition
exhibit about 70 N/mm to 85 N/mm tear strength.

17. The elastomeric formulation as claimed in anyone of claims 9 to 16, wherein filler 1 (N550), having iodine adsorption number, 43.2 mg/g; NSA, 36.09 m2/g; oil absorption number (OAN), 121 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
or
filler 2 (N115) having—Iodine adsorption number 162.0 mg/g; NSA 156.0 m2/g; oil absorption number 115.0 ml/100 g with 50 wt. % of total carbon black composition
exhibit about 40 N/mm to 55 N/mm tear strength.

18. The elastomeric formulation as claimed in anyone of claims 9 to 17, wherein, filler 1 N339 having iodine adsorption number, 89.0 mg/g; nitrogen surface area (NSA), 86.2 m2/g; oil absorption number (OAN), 119.8 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
exhibit 5.5 to 3.5 L* value.

19. The elastomeric formulation as claimed in anyone of claims 9 to 18, wherein Filler 1 N660 having iodine adsorption number, 37.5 mg/g; nitrogen surface area (NSA), 35.1 m2/g; oil absorption number (OAN), 91.2 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
exhibit about 10.5 to 9.5 L* value.

20. The elastomeric formulation as claimed in anyone of claims 9 to 19, wherein filler 1 N134 having iodine adsorption number, 146.75 mg/g; NSA, 139.9 m2/g; oil absorption number (OAN), 121.4 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
exhibit about 10.5 to 9.5 L* value.

21. The elastomeric formulation as claimed in anyone of claims 9 to 20 wherein Filler 1 N774 having iodine adsorption number, 30.5 mg/g; NSA, 31.5 m2/g; oil absorption number (OAN), 73.0 ml/100 g (OAN) and
Filler 2 EXP1 B219 having iodine adsorption number, 256.75 mg/g; NSA 262.98 m2/g; oil absorption number (OAN), 94.8 ml/100 g with 50 wt. % of the total carbon black composition
exhibit about 7.8 to 6.8 L* value.

22. The elastomeric formulation as claimed in anyone of claims 9 to 21, wherein filler 1 N774 having iodine adsorption number, 30.5 mg/g; NSA, 31.5 m2/g; oil absorption number (OAN), 73 ml/100 g (OAN) and
filler 2 EXP 3 (B361) having Iodine adsorption number 292.0 mg/g; NSA 294.0 m2/g; oil absorption number 70.0 ml/100 g; with 50 wt. % of the total carbon black composition
exhibit about 7.5 to 6.5 L* value.

23. The elastomeric formulation as claimed in anyone of claims 9 to 22, wherein filler 1 (N550), having iodine adsorption number, 43.2 mg/g; NSA, 36.09 m2/g; oil absorption number (OAN), 119.6 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
exhibit about 6.5 to 5.5 L* value.

24. The elastomeric formulation as claimed in anyone of claims 9 to 23, wherein filler 1 N550 having iodine adsorption number, 43.2 mg/g; NSA, 36.09 m2/g; oil absorption number (OAN), 121 ml/100 g and
filler 2 EXP2 (N115)—having Iodine adsorption number 162 mg/g; NSA 156 m2/g; oil absorption number 115 ml/100 g with 50 wt. % of the total carbon black composition
exhibit about 8.5 to 7.5 L* value.

25. The elastomeric formulation as claimed in anyone of claims 9 to 24, wherein filler 1 N660 having iodine adsorption number, 37.5 mg/g; nitrogen surface area (NSA), 35.1 m2/g; oil absorption number (OAN), 91.2 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
exhibit to 10.0 mm to 9.0 mm cut growth for 10 KC and 15.0 mm to 14.0 mm for 20 KC with a total carbon black loading of 45 phr.

26. The elastomeric formulation as claimed in anyone of claims 9 to 24, wherein filler 1 N774 having iodine adsorption number, 30.5 mg/g; NSA, 31.5 m2/g; oil absorption number (OAN), 73.0 ml/100 g (OAN) and
filler 2 EXP1 B219 having iodine adsorption number, 256.75 mg/g; NSA 262.98 m2/g; oil absorption number (OAN), 94.8 ml/100 g with 50 wt. % of the total carbon black composition
exhibit about 13.0 mm to 12.0 mm cut growth for 10 KC with a total carbon black loading of 70 phr.

27. The elastomeric formulation as claimed in anyone of claims 9 to 24, wherein filler 1 N134 having iodine adsorption number, 146.75 mg/g; NSA, 139.9 m2/g; oil absorption number (OAN), 121.4 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
exhibit about 9.0 mm to 8.0 mm cut growth for 10 KC and 13.0 mm to 12.0 mm for 20 KC with a total carbon black loading of 60 phr.

28. The elastomeric formulation as claimed in anyone of claims 9 to 27, wherein filler 1 N339 having iodine adsorption number, 89.0 mg/g; nitrogen surface area (NSA), 86.2 m2/g; oil absorption number (OAN), 119.8 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
or
filler 1 N660 having iodine adsorption number, 37.5 mg/g; nitrogen surface area (NSA), 35.1 m2/g; oil absorption number (OAN), 91.2 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
or
filler 1 (N550), having iodine adsorption number, 43.2 mg/g; NSA, 36.09 m2/g; oil absorption number (OAN), 119.6 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
or
filler 1 N774 having iodine adsorption number, 30.5 mg/g; NSA, 31.5 m2/g; oil absorption number (OAN), 73.0 ml/100 g (OAN) and
filler 2 EXP1 B219 having iodine adsorption number, 256.75 mg/g; NSA 262.98 m2/g; oil absorption number (OAN), 94.8 ml/100 g with 50 wt. % of the total carbon black composition
exhibit about 240% to 750% elongation at break.

29. The elastomeric formulation as claimed in anyone of claims 9 to 27, wherein filler 1 N339 having iodine adsorption number, 89.0 mg/g; nitrogen surface area (NSA), 86.2 m2/g; oil absorption number (OAN), 119.8 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition or
filler 1 N660 having iodine adsorption number, 37.5 mg/g; nitrogen surface area (NSA), 35.1 m2/g; oil absorption number (OAN), 91.2 ml/100 g; and
filler 2, EXP1 B219 having iodine adsorption number, 256.75 mg/g; NSA 262.98 m2/g; oil absorption number (OAN), 94.8 ml/100 g with 50 wt. % of the total carbon black composition
or
filler 1 (N550), having iodine adsorption number, 43.2 mg/g; NSA, 36.09 m2/g; oil absorption number (OAN), 119.6 ml/100 g and,
filler 2, EXP1 B219 having iodine adsorption number, 256.75 mg/g; NSA 262.98 m2/g; oil absorption number (OAN), 94.8 ml/100 g with 50 wt. % of the total carbon black composition
or
filler 1 N774 having iodine adsorption number, 30.5 mg/g; NSA, 31.5 m2/g; oil absorption number (OAN), 73.0 ml/100 g (OAN) and
filler 2 EXP1 B219 having iodine adsorption number, 256.75 mg/g; NSA 262.98 m2/g; oil absorption number (OAN), 94.8 ml/100 g with 50 wt. % of the total carbon black composition
exhibit about 6.0 MPa to 28.0 MPa tensile strength.

30. A process for the manufacture of carbon black composition as claimed in claims 1-8 involving desired synergistically enhanced distribution of width of aggregate size ΔD50 suitable for elastomer compounds comprising
mixing a select combination of (a) at least one first carbon black, having iodine adsorption number in the range of about 25 to 160 mg/g, nitrogen surface area (NSA) in the range of 20 to 150 m2/g, oil absorption number (OAN) in the range of 70 to 140 ml/100 g; and (b) at least one second carbon black, having iodine adsorption number in the range of 160 to 300 mg/g, nitrogen surface area (NSA) in the range of 160 to 300 m2/g oil absorption number (OAN) in the range of 50 to 120 ml/100 g, and wherein said second carbon black, in the carbon black composition very between 0.5 wt. % and 99.5 wt. % having synergistically enhanced distribution of width of aggregate size ΔD50 in the range of 50 nm to 160 nm and ratio of mass weighted average aggregate size, D_{W}, and number weighted average aggregate size, D_{N} in the range of 1.4 to 4.02.

31. A process for the manufacture of elastomer compound incorporating the carbon black composition of anyone of claims 1 to 8 comprising:
involving a select combination of (A) carbon black composition of (a) at least one first carbon black, having iodine adsorption number in the range of about 25 to 160 mg/g, nitrogen surface area (NSA) in the range of 20 to 150 m2/g, oil absorption number (OAN) in the range of 70 to 140 ml/100 g; and (b) at least one second carbon black, having iodine adsorption number in the range of 160 to 300 mg/g, nitrogen surface area (NSA) in the range of 160 to 300 m2/g oil absorption number (OAN) in the range of 50 to 120 ml/100 g, and wherein said second carbon black, in the carbon black composition vary between 0.5 wt. % and 99.5 wt. % having synergistically enhanced distribution of width of aggregate size ΔD50 and (B) co-acting rubber compounds and following processing for producing elastomeric compounds with enhanced dispersibility of carbon black in the elastomer compound in the range of 87.71 to 99.87%.

32. Elastomeric compound having synergistically enhanced dispersion of carbon black including:
said dispersion of combination of (a) at least one first carbon black, having iodine adsorption number in the range of about 25 to 160 mg/g, nitrogen surface area (NSA) in the range of 20 to 150 m2/g, oil absorption number (OAN) in the range of 70 to 140 ml/100 g; and (b) at least one second carbon black, having iodine adsorption number in the range of 160 to 300 mg/g, oil absorption number (OAN) in the range of 50 to 120 ml/100 g, and wherein said second carbon black, having synergistically enhanced distribution of width of aggregate size ΔD50 in the range of 50 nm to 160 nm and having measure of broadness of the aggregate size distribution curve without inferring the smaller and larger aggregate size defined by ΔD50/D_{Mode} in the range of 0.63 to 0.9.

33. The elastomeric compounds as claimed in claim 32 comprising rubber compounds including at least one homo- or co-polymers of natural rubber, epoxidized natural rubber, styrene butadiene rubber (SBR), polybutadiene rubber (PBR), butyl rubber (IIR), chlorobutyl rubber (CIIR), bromobutyl rubber, neoprene rubber (CR), nitrile rubber (NBR), ethylene propylene rubber (EPR), ethylene propylene diene rubber (EPDM), ethylene vinyl acetate (EVA) rubber, polyacrylic rubber, polysulfide rubber, silicone rubbers, fluoro elastomers or thermoplastic elastomer preferably NR/BR, SBR/BR, NBR, EPDM and IIR.

34. The elastomeric compound as claimed in anyone of claim 31 or 32 having improved aesthetic, colour, mechanical properties including selectively L* value in in the range of 15.38 to 5.05; tear strength in in the range of 33 N/mm to 198 N/mm; cut growth in the range of 26.38 mm to 8.78 mm; tensile strength in the range of 5.57 MPa to 25.06 MPa and elongation at break in the range of 208% to 732%.
